(19) United States
(12) Patent Application Publication
(10) Pub. No.: US 2014/0194480 A1
(43) Pub. Date: Jul. 10, 2014

(54) METHODS FOR THE CONTROL OF TERMITES AND ANTS

(71) Applicants: Mark Hoppe, Stein (CH); Myriem El Qacemi, Stein (CH); Jerome Yves Cassayre, Stein (CH)

(72) Inventors: Mark Hoppe, Stein (CH); Myriem El Qacemi, Stein (CH); Jerome Yves Cassayre, Stein (CH)

(73) Assignee: SYNGENTA PARTICIPATIONS AG, Basel (CH)

(21) Appl. No.: 14/240,140

(22) PCT Filed: Aug. 27, 2012
(86) PCT No.: PCT/EP2012/066574

§ 371 Date: Feb. 21, 2014

(30) Foreign Application Priority Data
Aug. 25, 2011 (EP) 11178931.9
Aug. 25, 2011 (EP) 11178941.8

(51) Int. Cl. A01N 43/36; A01N 43/80

(52) U.S. Cl. CPC A01N 43/36; A01N 43/80
USPC 514/378; 514/422

(57) ABSTRACT

The present invention provides a method for controlling termites comprising applying a liquid formulation comprising a compound of formula I to a location where termite control is needed or is expected to be needed, wherein the compound of formula (I) is wherein X is optionally substituted aryl, optionally substituted heterocyclyl, or a group selected from X1 to X5 cycle A is aryl or heteroaryl; cycle B is a saturated or partially unsaturated heterocyclyl; cycle C is aryl or heteroaryl; R¹, R², R³, R⁴, R⁵, R⁶ and R⁸ are independently hydrogen or an organic radical; R⁷ is haloalkyl; G is oxygen or sulfur; L is O, NH, NR¹, CR³R⁴; n is 0, 1, 2, 3, 4 or 5; o is 0, 1, 2, 3, 4 or 5; p is 1, 2, 3, 4 or 5. The invention also relates to methods for protecting man-made structures from termites using the compounds of formula I as well as termite baits comprising the compound of formula I. The invention also provides a method for controlling ants comprising applying a liquid formulation comprising a compound of formula I to a location where ant control is needed or is expected to be needed.

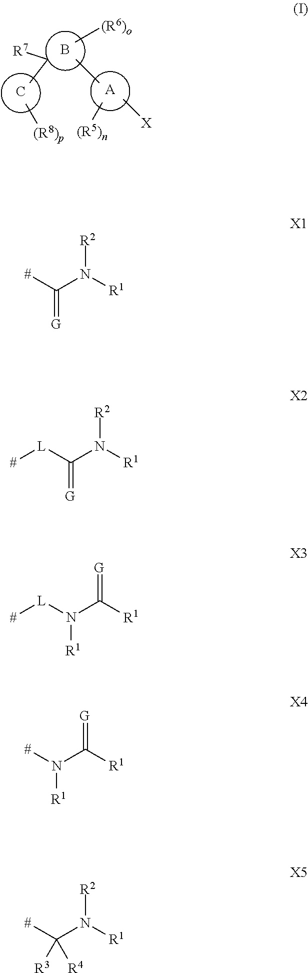

The present invention relates to methods of controlling social insects, in particular termites, and in particular to methods of controlling termites using compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings.

Termites are estimated to cause 1.5 billion dollars of damage to structures annually, and an additional one billion dollars is spent on treatment.

There are two types of termites, described as i) dry wood termites, and ii) subterranean termites. Of these two types, the subterranean termites usually live in the soil (i.e., soil-borne), from which they build tunnels or mud tubes to structural wood where they then feed. The major pest species such as Reticulitermes and Coptotermes, may have between 20,000 and 1,000,000 individuals in a colony that is causing a problem and their tunnels can extend up to 50 m and more from the main focus of the nest.

Control of soil-borne termites can be accomplished by strategic application of a termiticide to the soil where there is a termite infestation, to provide a continuous chemical barrier in soil surrounding and beneath a structure. The preferred method for control of soil-borne termites is by the application of a termiticide directly to the soil, thereby creating a chemical barrier in the soil.

Termiticides can be classified as repellent or non-repellent (Remmen et al. J. Econ. Entomol. 2005, 98(3), 906-910; Hu, J. Econ. Entomol. 2005, 98(2), 509-517). Historically, repellent termiticides such as pyrethroids have been extensively used to protect properties but the drawback is that careful application is needed. If there are gaps in the application the termites may find a way through thereby establishing a pathway and leading to termite infestation (Forschler et al., J. Entomol. Sci. 1994, 29(1) 43-54). In addition, repellent termiticides do not destroy the colony, meaning that the risk of termites finding gaps will always remain. Examples of repellent termiticides that have been extensively used are cypermethrin, permethrin. Non-repellent termiticides allow termites to tunnel into soil containing a lethal dose of the termiticide. They are considered to be superior products because less care is needed in applying the termiticides in order to bring about robust results. In addition, slow acting non-repellent termiticides may also be transferred back to the nest, potentially leading to destruction of the colony. Examples of non-repellent termiticides are imidacloprid and fipronil.

In addition to non-repellency a new termiticide should be stable in a soil environment, and should not leach from soil. It is also desirable that a termiticide is effective at low rates to minimise environmental impact. Many insecticidal compounds will prima facie kill termites, but do not have the physical properties needed to make them effective termiticdes.

Compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings, represent a new class of pesticides that are described for example in Ozoe et al. Biochemical and Biophysical Research Communications, 391 (2010) 744-749. Compounds from this class are broadly described in WO 2005/085216 (EP1731512), WO 2007/123853, WO 2007/075459, WO2009/002809, WO 2008/019760, WO 2008/122375, WO 2008/128711, WO 2009/097992, WO 2010/072781, WO 2010/072781, WO 2008/126665, WO 2007/125984, WO 2008/130651, JP 2008110971, JP2008133273, WO2009/022746, WO 2009/022746, WO 2010/032437, WO2009/080250, WO2010/020521, WO2010/025998, WO2010/020522, WO2010/084067, WO2010/086225, WO2010/149506 and WO2010/108733, all of which are incorporated herein by reference. No compounds from this class have yet been commercialised.

It has now surprisingly been found that termites will tunnel into soil treated with a lethal dose of compounds from the above class of insecticides, indicating that these compounds are non-repellent to termites. The tunnelling response of a termite to a termiticide is often used for identifying whether a compound is repellent, see e.g. Yeoh et al., Sociobiology, vol. 50, no. 2, 2007, which is incorporated herein by reference. It has also been found that these compounds are sufficiently slow acting that termites may return to the colony without showing signs of intoxication. These compounds are also substantially stable in a soil environment and substantially do not leach from the soil, as well as being highly potent. Compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings, therefore represent a potentially valuable new solution for combating termite infestation.

In a general aspect the invention provides a method of controlling termites comprising applying as a non-repellent termiticide, a compound that is insecticidally active by antagonism of the gamma-aminobutyric acid (GABA)-gated chloride channel, and which comprises a partially saturated heterocycle that is substituted by a haloalkyl substituent and one or two optionally substituted aromatic or heteroaromatic rings, as a non-repellent termiticide to a location where termite control is needed or is expected to be needed.

In a first aspect the invention provides a method for controlling termites comprising applying a liquid formulation comprising a compound of formula I to a location where termite control is needed or is expected to be needed, wherein the compound of formula I is

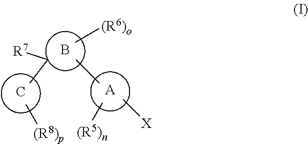

wherein

X is optionally substituted aryl, optionally substituted heterocyclyl, or a group selected from X1 to X5

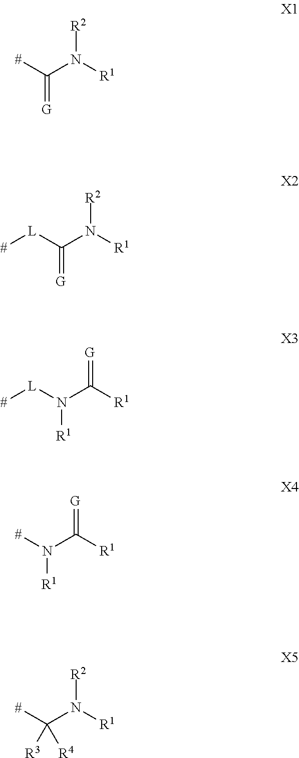

cycle A is aryl or heteroaryl;

cycle B is a saturated or partially unsaturated heterocyclyl;

cycle C is aryl or heteroaryl;

R¹, R², R³, R⁴, R⁵, R⁶ and R⁸ are independently hydrogen or an organic radical;

R⁷ is haloalkyl;

G is oxygen or sulfur;

L is O, NH, NR¹, CR³R⁴;

n is 0, 1, 2, 3, 4 or 5;

o is 0, 1, 2, 3, 4 or 5;

p is 1, 2, 3, 4 or 5.

The compounds of formula (I) may exist in different geometric or optical isomers or tautomeric forms. This invention covers all such isomers and tautomers and mixtures thereof in all proportions as well as isotopic forms such as deuterated compounds.

The compounds of the invention may contain one or more asymmetric carbon atoms, for example, at the —CR³R⁴— group, and may exist as enantiomers (or as pairs of diastereoisomers) or as mixtures of such.

Alkyl groups (either alone or as part of a larger group, such as alkoxy-, alkylthio-, alkylsulfinyl-, alkylsulfonyl-, alkylcarbonyl- or alkoxycarbonyl-) can be in the form of a straight or branched chain and are, for example, methyl, ethyl, propyl, prop-2-yl, butyl, but-2-yl, 2-methyl-prop-1-yl or 2-methyl-prop-2-yl. The alkyl groups are preferably C₁-C₆, more preferably C₁-C₄, most preferably C₁-C₃ alkyl groups. Where an alkyl moiety is said to be substituted, the alkyl moiety is preferably substituted by one to four substituents, most preferably by one to three substituents.

Alkylene groups can be in the form of a straight or branched chain and are, for example, —CH₂—, —CH₂—CH₂—, —CH(CH₃)—, —CH₂—CH₂—CH₂—, —CH(CH₃)—CH₂—, or —CH(CH₂CH₃)—. The alkylene groups are preferably C₁-C₃, more preferably C₁-C₂, most preferably C₁ alkylene groups.

Alkenyl groups can be in the form of straight or branched chains, and can be, where appropriate, of either the (E)- or (Z)-configuration. Examples are vinyl and allyl. The alkenyl groups are preferably C₂-C₆, more preferably C₂-C₄, most preferably C₂-C₃ alkenyl groups.

Alkynyl groups can be in the form of straight or branched chains. Examples are ethynyl and propargyl. The alkynyl groups are preferably C₂-C₆, more preferably C₂-C₄, most preferably C₂-C₃ alkynyl groups.

Halogen is fluorine, chlorine, bromine or iodine.

Haloalkyl groups (either alone or as part of a larger group, such as haloalkoxy-, haloalkylthio-, haloalkylsulfinyl- or haloalkylsulfonyl-) are alkyl groups which are substituted by one or more of the same or different halogen atoms and are, for example, difluoromethyl, trifluoromethyl, chlorodifluoromethyl or 2,2,2-trifluoro-ethyl.

Haloalkenyl groups are alkenyl groups which are substituted by one or more of the same or different halogen atoms and are, for example, 2,2-difluoro-vinyl or 1,2-dichloro-2-fluoro-vinyl.

Haloalkynyl groups are alkynyl groups which are substituted by one or more of the same or different halogen atoms and are, for example, 1-chloro-prop-2-ynyl.

Cycloalkyl groups or carbocyclic rings can be in mono- or bi-cyclic form and are, for example, cyclopropyl, cyclobutyl, cyclohexyl and bicyclo[2.2.1]heptan-2-yl. The cycloalkyl groups are preferably C₃-C₈, more preferably C₃-C₆ cycloalkyl groups. Where a cycloalkyl moiety is said to be substituted, the cycloalkyl moiety is preferably substituted by one to four substituents, most preferably by one to three substituents.

Aryl groups (either alone or as part of a larger group, such as aryl-alkylene-) are aromatic ring systems which can be in mono-, bi- or tricyclic form. Examples of such rings include phenyl, naphthyl, anthracenyl, indenyl or phenanthrenyl. Preferred aryl groups are phenyl and naphthyl, phenyl being most preferred. Where an aryl moiety is said to be substituted, the aryl moiety is preferably substituted by one to four substituents, most preferably by one to three substituents.

Heteroaryl groups (either alone or as part of a larger group, such as heteroaryl-alkylene-) are aromatic ring system containing at least one heteroatom and consisting either of a single ring or of two or more fused rings. Preferably, single rings will contain up to three heteroatoms and bicyclic systems up to four heteroatoms which will preferably be chosen from nitrogen, oxygen and sulfur. Examples of monocyclic groups include pyridyl, pyridazinyl, pyrimidinyl, pyrazinyl, pyrrolyl, pyrazolyl, imidazolyl, triazolyl, furanyl, thiophenyl, oxazolyl, isoxazolyl, oxadiazolyl, thiazolyl, isothiazolyl and thiadiazolyl. Examples of bicyclic groups include quinolinyl, cinnolinyl, quinoxalinyl, indolyl, indazolyl, benzimidazolyl, benzothiophenyl and benzothiazolyl. Monocyclic heteroaryl groups are preferred, pyridyl being most preferred. Where a heteroaryl moiety is said to be substituted, the heteroaryl moiety is preferably substituted by one to four substituents, most preferably by one to three substituents.

Heterocyclyl groups or heterocyclic rings (either alone or as part of a larger group, such as heterocyclyl-alkylene-) are defined to include heteroaryl groups and in addition their unsaturated or partially unsaturated analogues. Examples of monocyclic groups include thietanyl, pyrrolidinyl, tetrahydrofuranyl, isoxazolinyl, 2,3-dihydrofuranyl, 2,5-dihydrorfuranyl, 3,4-dihydro-2H-pyrrolyl, oxazolidin-2-one-yl, [1,3]dioxolanyl, piperidinyl, piperazinyl, [1,4]dioxanyl, and morpholinyl or their oxidised versions such as 1-oxo-thietanyl and 1,1-dioxo-thietanyl. Examples of bicyclic groups include 2,3-dihydro-benzofuranyl, benzo[1,3]dioxolanyl, and 2,3-dihydro-benzo[1,4]dioxinyl. Where a heterocyclyl moiety is said to be substituted, the heterocyclyl moiety is preferably substituted by one to four substituents, most preferably by one to three substituents.

Preferred values of cycle A, cycle B, cycle C, X, A¹, A², A³, A⁴, A^{1′}, A^{2′}, A^{3′}, A^{4′}, A^{5′}, A^{6′}, G, R¹, R², R³, R⁴, R⁵, R⁶, R⁷, R⁸, R⁹, R¹⁰, R¹¹, R¹², R¹³, R¹⁴, R¹⁵, Z, n, o, p and k are in any combination, as set out below.

Preferably cycle A is A1 or A2

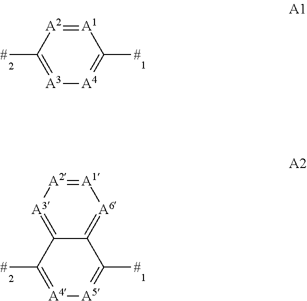

wherein A¹, A², A³, A⁴, A^{1′}, A^{2′}, A^{3′}, A^{4′}, A^{5′} and A^{6′} are independently of each other C—H, C—R⁵, or nitrogen, wherein #1 indicates the bond to X and #2 indicates the bond to cycle B. More preferably cycle A is A1a or A2a

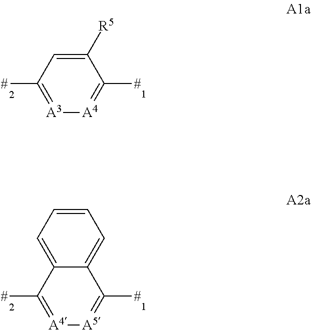

wherein A³, A⁴, A^{5′} and A^{6′} are independently C—H, or nitrogen. Most preferably cycle A is cycle A1a in which A³ and A⁴ are C—H.

Preferably cycle B is selected from B1 to B6

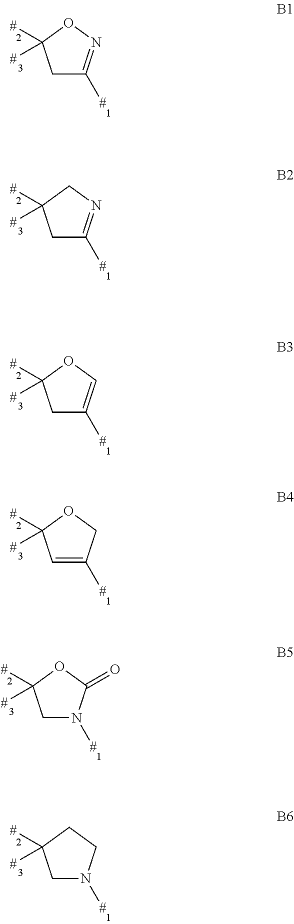

wherein #1 indicates the bond to cycle A, #2 indicates the bond to R⁷ and #3 indicates the bond to cycle C. Preferably cycle B is cycle selected from cycle B1, B2 and B3, more preferably B 1.

Preferably cycle C is cycle C1

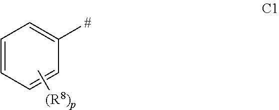

More preferably cycle C is 3,5-dibromo-phenyl, 3,5-dichloro-phenyl, 3,4-dichloro-phenyl, 3,5-dichloro-4-fluoro-phenyl or 3,4,5-trichloro-phenyl.

Preferably X is selected from X1 to X5 and XH1 to XH9

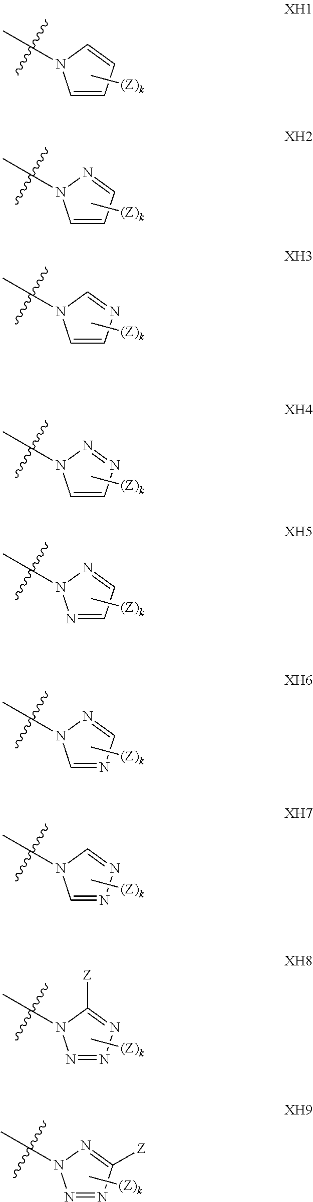

wherein Z is an organic radical and k is 0, 1 or 2. More preferably X is X1. Even more preferably X is selected from P1 to P64, more preferably X is P1 or P2.

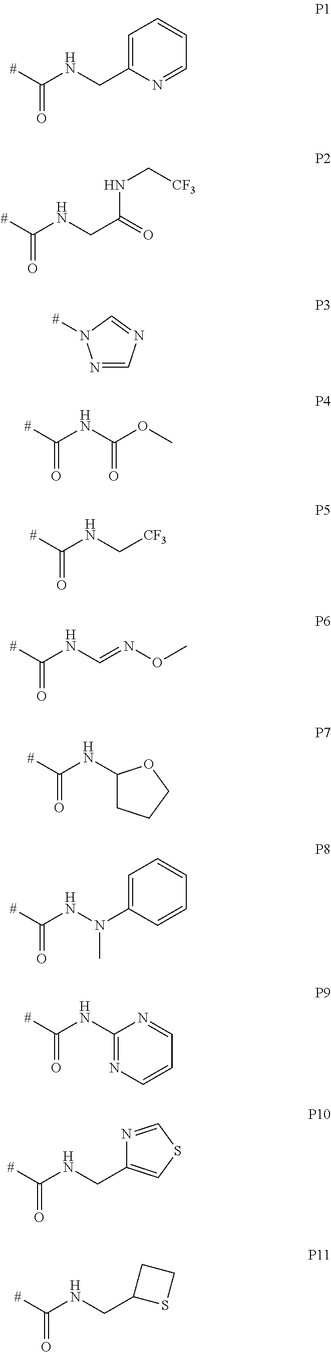

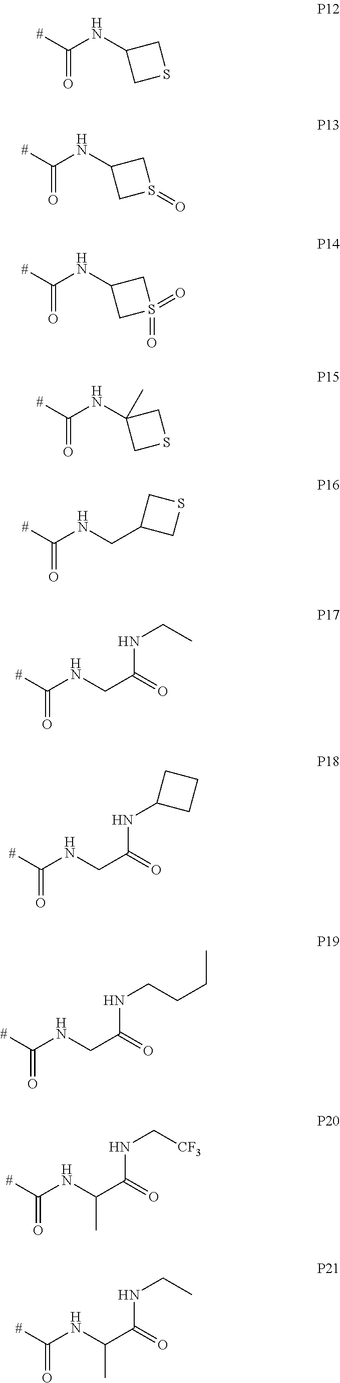

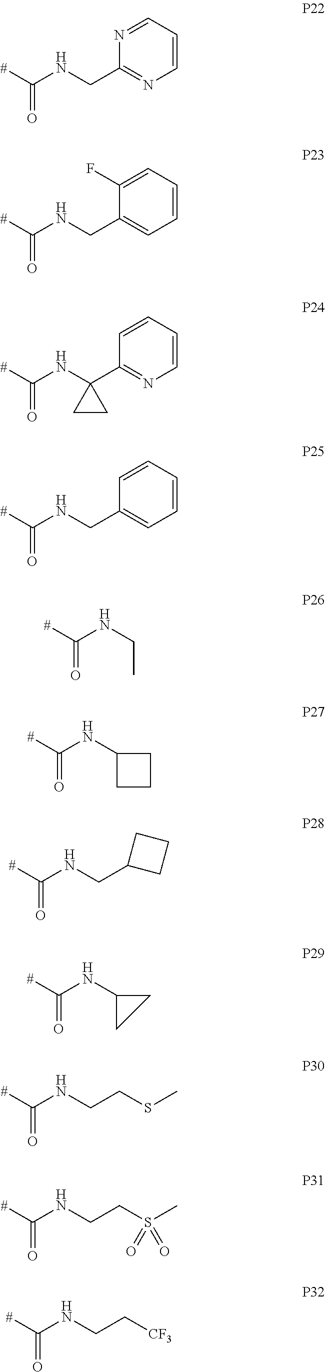

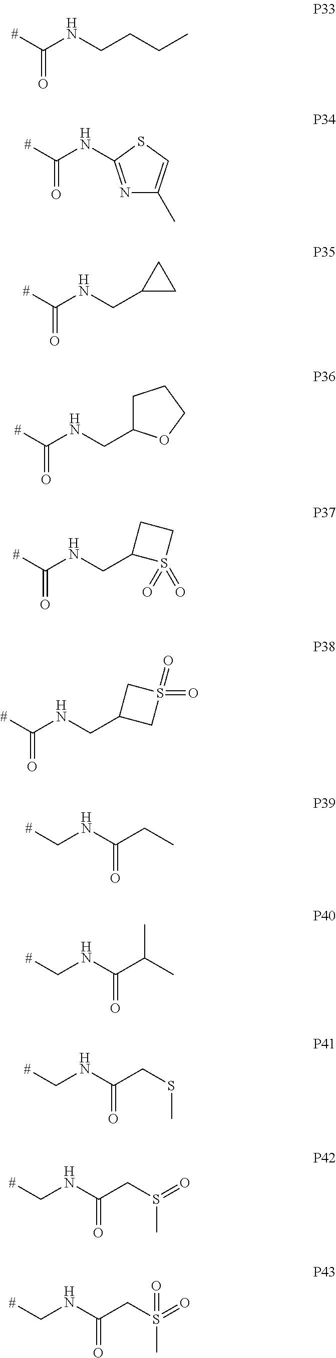

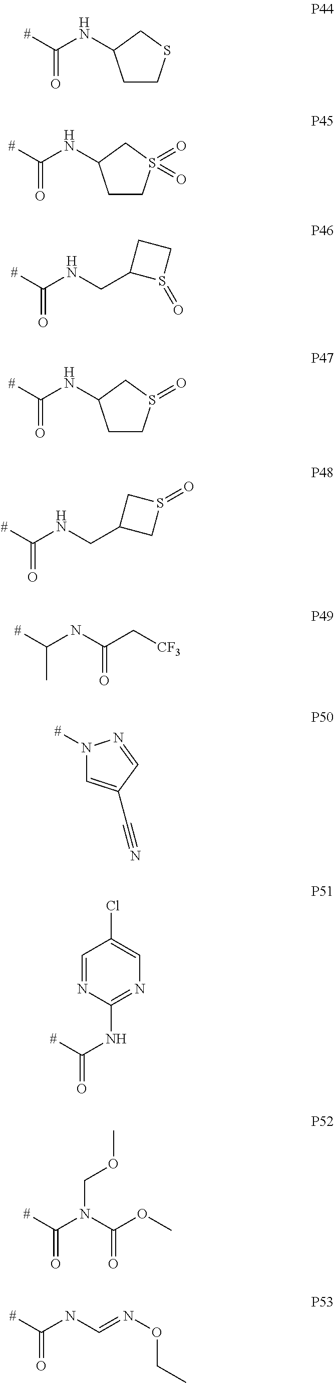

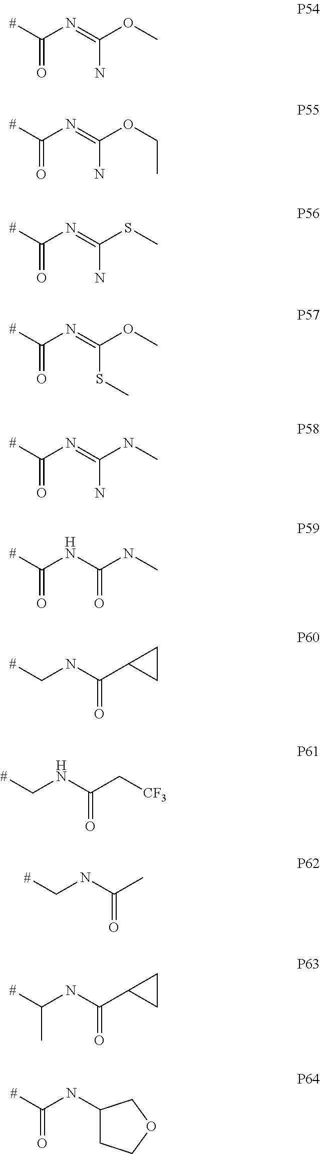

Preferably A¹ is C—H or C—R⁵, most preferably A¹ is C—R⁵.

Preferably A² is C—H or C—R⁵, most preferably A² is C—H.

Preferably A³ is C—H or C—R⁵, most preferably A³ is C—H.

Preferably A⁴ is C—H or C—R⁵, most preferably A⁴ is C—H.

Preferably A^{1′} is C—H or C—R⁵, most preferably A^{1′} is C—H.

Preferably A^{2′} is C—H or C—R⁵, most preferably A^{2′} is C—H.

Preferably A^{3′} is C—H or C—R⁵, most preferably A^{3′} is C—H.

Preferably A^{4′} is C—H or C—R⁵, most preferably A^{4′} is C—H.

Preferably A^{5′} is C—H or C—R⁵, most preferably A^{5′} is C—H.

Preferably A^{6′} is C—H or C—R⁵, most preferably A^{6′} is C—H.

Preferably no more than two of A¹, A², A³ and A⁴ are nitrogen, preferably no more than one is nitrogen. Preferably no more than two of A^{1′}, A^{2′}, A^{3′}, A^{4′}, A^{5′} and A^{6′} are nitrogen, more preferably no more than one is nitrogen.

G is preferably oxygen.

Preferably R¹ is hydrogen, C₁-C₈alkyl, C₁-C₈alkoxy-, C₁-C₈alkylcarbonyl-, or C₁-C₈alkoxycarbonyl-, more preferably hydrogen, methyl, ethyl, methylcarbonyl-, or methoxycarbonyl-, even more preferably hydrogen, methyl or ethyl, most preferably hydrogen.

Preferably R² is C₁-C₈alkyl or C₁-C₈alkyl substituted by one to five R¹², C₃-C₁₀cycloalkyl or C₃-C₁₀cycloalkyl substituted by one to five R¹³, aryl-C₁-C₄alkylene- or aryl-C₁-C₄alkylene- wherein the aryl moiety is substituted by one to five R¹⁴, heterocyclyl-C₁-C₄alkylene- or heterocyclyl-C₁-C₄alkylene- wherein the heterocyclyl moiety is substituted by one to five R¹⁴, aryl or aryl substituted by one to five R¹⁴, heterocyclyl or heterocyclyl substituted by one to five R¹⁴, C₁-C₈alkylaminocarbonyl-C₁-C₄ alkylene, C₁-C₈haloalkylaminocarbonyl-C₁-C₄ alkylene, C₃-C₈cycloalkyl-aminocarbonyl-C₁-C₄ alkylene, C₁-C₆alkyl-O—N═CH—, C₁-C₆haloalkyl-O—N═CH—, and wherein preferably each aryl group is a phenyl group and each heterocycle group is selected from pyridyl, pyridazinyl, pyrimidinyl, pyrazinyl, pyrrolyl, pyrazolyl, imidazolyl, triazolyl, tetrahydrothiophenyl, tetrazolyl, furanyl, thiophenyl, oxazolyl, isoxazolyl, oxadiazolyl, thiazolyl, isothiazolyl, thiadiazolyl, quinolinyl, cinnolinyl, quinoxalinyl, indolyl, indazolyl, benzimidazolyl, benzothiophenyl, benzothiazolyl, oxetanyl, thietanyl, oxo-thietanyl, dioxo-thietanyl, pyrrolidinyl, tetrahydrofuranyl, [1,3]dioxolanyl, piperidinyl, piperazinyl, [1,4]dioxanyl, morpholinyl, 2,3-dihydro-benzofuranyl, benzo[1,3]dioxolanyl, and 2,3-dihydro-benzo[1,4]dioxinyl, more preferably pyridyl, pyrimidinyl, thiazolyl, and tetrahydrofuranyl.

Preferably R³ and R⁴ are independently halogen, hydrogen, C₁-C₁₂alkyl or C₁-C₁₂alkyl substituted by one to five R¹², C₃-C₈cycloalkyl or C₃-C₈cycloalkyl substituted by one to five R¹³, C₂-C₁₂alkenyl or C₂-C₁₂alkenyl substituted by one to five R¹², C₂-C₁₂alkynyl or C₂-C₁₂alkynyl substituted by one to five R¹², cyano, C₁-C₁₂alkoxycarbonyl or C₁-C₁₂alkoxycarbonyl substituted by one to five R¹², C₁-C₁₂alkoxythiocarbonyl or C₁-C₁₂alkoxythiocarbonyl substituted by one to five R¹², or R³ and R⁴ together with the carbon atom to which they are attached may form a 3 to 6-membered carbocyclic ring. Preferably, R³ and R⁴ are each independently hydrogen, halogen, C₁-C₁₂alkyl, C₁-C₁₂haloalkyl, C₃-C₈cycloalkyl, C₃-C₈halocycloalkyl, C₂-C₁₂alkenyl, C₂-C₁₂haloalkenyl, C₂-C₁₂alkynyl, C₂-C₁₂haloalkynyl, cyano, C₁-C₁₂alkoxycarbonyl, C₁-C₁₂haloalkoxycarbonyl, C₁-C₁₂alkoxythiocarbonyl, C₁-C₁₂haloalkoxythiocarbonyl, or R³ and R⁴ together with the carbon atom to which they are attached may form a 3 to 6-membered carbocyclic ring. More preferably, R³ and R⁴ are each independently hydrogen, halogen, cyano, C₁-C₄alkyl or C₁-C₄haloalkyl, even more preferably R³ and R⁴ are hydrogen, halogen or methyl, most preferably hydrogen.

Preferably each R⁵ is independently halogen, cyano, nitro, C₁-C₈alkyl, C₁-C₈haloalkyl, C₂-C₈alkenyl, C₂-C₈haloalkenyl, C₂-C₈alkynyl, C₃-C₁₀cycloalkyl, C₁-C₈alkoxy-, C₁-C₈haloalkoxy-, or C₁-C₈alkoxycarbonyl-, more preferably bromo, chloro, fluoro, cyano, nitro, methyl, ethyl, trifluoromethyl, vinyl, methoxy, difluoromethoxy, or trifluoromethoxy, even more preferably chloro, bromo, CF₃ or methyl, most preferably methyl.

Preferably each R⁶ is independently halogen, cyano, C₁-C₈alkyl, C₁-C₈haloalkyl, hydroxy, C₁-C₈alkoxy-, C₁-C₈haloalkoxy-, C₁-C₈alkylthio-, C₁-C₈haloalkylthio-, C₁-C₈alkylsulfinyl-, C₁-C₈haloalkylsulfinyl-, C₁-C₈alkylsulfonyl-, or C₁-C₈haloalkylsulfonyl-, or if two R⁶ are attached to the same carbon atom the two R⁶ may together form ═O, ═N—OR⁹ or ═CR¹⁰R¹¹;

Preferably R⁷ is C₁-C₈haloalkyl, more preferably chlorodifluoromethyl or trifluoromethyl, most preferably trifluoromethyl.

Preferably each R⁸ is independently halogen, cyano, nitro, C₁-C₈alkyl, C₁-C₈haloalkyl, C₁-C₈alkoxy-, C₁-C₈haloalkoxy-, C₁-C₈alkoxycarbonyl-, C₁-C₈alkylthio-, C₁-C₈haloalkylthio-, C₁-C₈alkylsulfinyl-, C₁-C₈haloalkylsulfinyl-, C₁-C₈alkylsulfonyl-, or C₁-C₈haloalkylsulfonyl-, more preferably C₁-C₈alkyl, C₁-C₈haloalkyl, C₁-C₈alkoxy-, C₁-C₈haloalkoxy-, C₁-C₈alkylthio-, or C₁-C₈haloalkylthio-, even more preferably bromo, chloro, fluoro, trifluoromethyl, methoxy, or methylthio, more preferably R⁸ bromo, chloro, fluoro or trifluoromethyl, most preferably bromo or chloro.

R⁹ is hydrogen or C₁-C₄alkyl.

R¹⁰ and R¹¹ are independently of each other hydrogen or C₁-C₄alkyl.

Each R¹² is independently halogen, cyano, nitro, hydroxy, amino, C₁-C₈alkylamino, (C₁-C₈alkyl)₂amino, C₁-C₈alkylcarbonylamino, C₁-C₈haloalkylcarbonylamino, C₁-C₈alkoxy-, C₁-C₈haloalkoxy-, aryloxy or aryloxy substituted by one to five R¹⁵, aryloxy-C₁-C₄alkylene or aryloxy-C₁-C₄alkylene wherein the aryl moiety is substituted by one to five R¹⁵, C₁-C₈alkylcarbonyl-, C₁-C₈alkoxycarbonyl-, mercapto, C₁-C₈alkylthio-, C₁-C₈haloalkylthio-, C₁-C₈alkylsulfinyl-, C₁-C₈haloalkylsulfinyl-, C₁-C₈alkylsulfonyl-, C₁-C₈haloalkylsulfonyl-, aryl-C₁-C₄alkylthio or aryl-C₁-C₄alkylthio wherein the aryl moiety is substituted by one to five R¹⁵. Preferably each R¹² is independently halogen, cyano, nitro, hydroxy, C₁-C₈alkoxy-, C₁-C₈haloalkoxy-, mercapto, C₁-C₈alkylthio-, C₁-C₈haloalkylthio-, more preferably bromo, chloro, fluoro, methoxy, or methylthio, most preferably chloro, fluoro, or methoxy.

Each R¹³ is independently halogen, C₁-C₈alkyl, C₁-C₈alkenyl, C₁-C₈alkynyl, C₁-C₈alkyl-O—N═, C₁-C₈haloalkyl-O—N═; C₁-C₈alkoxy, C₁-C₈akoxycarbonyl, more preferably halogen or C₁-C₈alkyl, more preferably chloro, fluoro or methyl, most preferably methyl.

Each R¹⁴ is independently halogen, cyano, nitro, oxo, C₁-C₈alkyl, C₁-C₈haloalkyl, C₁-C₈cyanoalkyl, C₂-C₈alkenyl, C₂-C₈haloalkenyl, C₂-C₈alkynyl, C₂-C₈haloalkynyl, C₃-C₁₀cycloalkyl, C₃-C₁₀cycloalkyl-C₁-C₄alkylene, hydroxy, C₁-C₈alkoxy-, C₁-C₈haloalkoxy-, mercapto, C₁-C₈alkylthio-, C₁-C₈haloalkylthio-, C₁-C₈alkylsulfinyl-, C₁-C₈haloalkylsulfinyl-, C₁-C₈alkylsulfonyl-, C₁-C₈haloalkylsulfonyl-, C₁-C₈alkylaminosulfonyl, (C₁-C₈alkyl)₂aminosulfonyl-, C₁-C₈alkylcarbonyl-, C₁-C₈alkoxycarbonyl-, aryl or aryl substituted by one to five R¹⁵, heterocyclyl or heterocyclyl substituted by one to five R¹⁵, aryl-C₁-C₄alkylene or aryl-C₁-C₄alkylene wherein the aryl moiety is substituted by one to five R¹⁵, heterocyclyl-C₁-C₄alkylene or heterocyclyl-C₁-C₄alkylene wherein the heterocyclyl moiety is substituted by one to five R¹⁵, aryloxy or aryloxy substituted by one to five R¹⁵, aryloxy-C₁-C₄alkylene or aryloxy-C₁-C₄alkylene wherein the aryl moiety is substituted by one to five R¹⁵. Preferably each R¹⁴ is independently halogen, cyano, nitro, C₁-C₈alkyl, C₁-C₈haloalkyl, C₁-C₈alkoxy-, C₁-C₈haloalkoxy-, more preferably bromo, chloro, fluoro, cyano, nitro, methyl, ethyl, trifluoromethyl, methoxy, difluoromethoxy, or trifluoromethoxy, most preferably bromo, chloro, fluoro, cyano or methyl.

Each R¹⁵ is independently halogen, cyano, nitro, C₁-C₄alkyl, C₁-C₄haloalkyl, C₁-C₄alkoxy-, or C₁-C₄haloalkoxy-.

Each Z is independently halogen, C₁-C₁₂alkyl or C₁-C₁₂alkyl substituted by one to five R¹², nitro, C₁-C₁₂alkoxy or C₁-C₁₂alkoxy substituted by one to five R¹², cyano, C₁-C₁₂alkylsulfinyl, C₁-C₁₂alkylsulfonyl, C₁-C₁₂haloalkylsulfinyl, C₁-C₁₂haloalkylsulfonyl, hydroxyl or thiol, preferably each Z is independently halogen, cyano, C₁-C₄alkyl, C₁-C₄haloalkyl, C₁-C₄alkoxy, or C₁-C₄haloalkoxy, more preferably each Z is independently hydrogen, halogen, methyl, halomethyl, methoxy or halomethoxy.

n is preferably 0, 1, 2, 3, preferably 1. o is preferably 0, 1, 2, or 3, preferably 0 or 1, most preferably 0. p is preferably 1, 2, 3, preferably 2 or 3, preferably 2.

In a preferred group of compounds cycle A is A1 or A2, cycle B is selected from B1 to B6 and cycle C is C1.

In another preferred group of compounds X is selected from X1 to X5 and XH1 to XH9.

In yet another preferred group of compounds

R¹ is hydrogen, C₁-C₈alkyl, C₁-C₈alkoxy-, C₁-C₈alkylcarbonyl-, or C₁-C₈alkoxycarbonyl-;

R² is C₁-C₈alkyl or C₁-C₈alkyl substituted by one to five R¹², C₃-C₁₀cycloalkyl or C₃-C₁₀cycloalkyl substituted by one to five R¹³, aryl-C₁-C₄alkylene- or aryl-C₁-C₄alkylene- wherein the aryl moiety is substituted by one to five R¹⁴, heterocyclyl-C₁-C₄alkylene- or heterocyclyl-C₁-C₄alkylene- wherein the heterocyclyl moiety is substituted by one to five R¹⁴, aryl or aryl substituted by one to five R¹⁴, heterocyclyl or heterocyclyl substituted by one to five R¹⁴, C₁-C₈alkylaminocarbonyl-C₁-C₄ alkylene, C₁-C₈haloalkylaminocarbonyl-C₁-C₄ alkylene, C₃-C₈cycloalkyl-aminocarbonyl-C₁-C₄ alkylene, C₁-C₆alkyl-O—N═CH—, C₁-C₆haloalkyl-O—N═CH—;

R³ and R⁴ are independently halogen, hydrogen, C₁-C₁₂alkyl or C₁-C₁₂alkyl substituted by one to five R¹², C₃-C₈cycloalkyl or C₃-C₈cycloalkyl substituted by one to five R¹³, C_{2′} C₁₂alkenyl or C₂-C₁₂alkenyl substituted by one to five R¹², C₂-C₁₂alkynyl or C₂-C₁₂alkynyl substituted by one to five R¹², cyano, C₁-C₁₂alkoxycarbonyl or C₁-C₁₂alkoxycarbonyl substituted by one to five R¹², C₁-C₁₂alkoxythiocarbonyl or C₁-C₁₂alkoxythiocarbonyl substituted by one to five R¹², or R³ and R⁴ together with the carbon atom to which they are attached may form a 3 to 6-membered carbocyclic ring;

each R⁵ is independently halogen, cyano, nitro, C₁-C₈alkyl, C₁-C₈haloalkyl, C₂-C₈alkenyl, C₂-C₈haloalkenyl, C₂-C₈alkynyl, C₃-C₁₀cycloalkyl, C₁-C₈alkoxy-, C₁-C₈haloalkoxy-, or C₁-C₈alkoxycarbonyl-;

each R⁶ is independently halogen, cyano, C₁-C₈alkyl, C₁-C₈haloalkyl, hydroxy, C₁-C₈alkoxy-, C₁-C₈haloalkoxy-, C₁-C₈alkylthio-, C₁-C₈haloalkylthio-, C₁-C₈alkylsulfinyl-, C₁-C₈haloalkylsulfinyl-, C₁-C₈alkylsulfonyl-, or C₁-C₈haloalkylsulfonyl-, or

if two R⁶ are attached to the same carbon atom the two R⁴ may together form ═O, ═N—OR⁹ or ═CR¹⁰R¹¹;

R⁷ is C₁-C₈haloalkyl;

each R⁸ is independently halogen, cyano, nitro, C₁-C₈alkyl, C₁-C₈haloalkyl, C₁-C₈alkoxy-, C₁-C₈haloalkoxy-, C₁-C₈alkoxycarbonyl-, C₁-C₈alkylthio-, C₁-C₈haloalkylthio-, C₁-C₈alkylsulfinyl-, C₁-C₈haloalkylsulfinyl-, C₁-C₈alkylsulfonyl-, or C₁-C₈haloalkylsulfonyl-;

R⁹ is hydrogen or C₁-C₄alkyl;

R¹⁰ and R¹¹ are independently of each other hydrogen or C₁-C₄alkyl;

each R¹² is independently halogen, cyano, nitro, hydroxy, amino, C₁-C₈alkylamino, (C₁-C₈alkyl)₂amino, C₁-C₈alkylcarbonylamino, C₁-C₈haloalkylcarbonylamino, C₁-C₈alkoxy-, C₁-C₈haloalkoxy-, aryloxy or aryloxy substituted by one to five R¹⁵, aryloxy-C₁-C₄alkylene or aryloxy-C₁-C₄alkylene wherein the aryl moiety is substituted by one to five R¹⁵, C₁-C₈alkylcarbonyl-, C₁-C₈alkoxycarbonyl-, mercapto, C₁-C₈alkylthio-, C₁-C₈haloalkylthio-, C₁-C₈alkylsulfinyl-, C₁-C₈haloalkylsulfinyl-, C₁-C₈alkylsulfonyl-, C₁-C₈haloalkylsulfonyl-, aryl-C₁-C₄alkylthio or aryl-C₁-C₄alkylthio wherein the aryl moiety is substituted by one to five R¹⁵;

each R¹³ is independently halogen, C₁-C₈alkyl, C₁-C₈alkenyl, C₁-C₈alkynyl, C₁-C₈alkyl-O—N═, C₁-C₈haloalkyl-O—N═; C₁-C₈alkoxy, C₁-C₈akoxycarbonyl;

each R¹⁴ is independently halogen, cyano, nitro, oxo, C₁-C₈alkyl, C₁-C₈haloalkyl, C₁-C₈cyanoalkyl, C₂-C₈alkenyl, C₂-C₈haloalkenyl, C₂-C₈alkynyl, C₂-C₈haloalkynyl, C₃-C₁₀cycloalkyl, C₃-C₁₀cycloalkyl-C₁-C₄alkylene, hydroxy, C₁-C₈alkoxy-, C₁-C₈haloalkoxy-, mercapto, C₁-C₈alkylthio-, C₁-C₈haloalkylthio-, C₁-C₈alkylsulfinyl-, C₁-C₈haloalkylsulfinyl-, C₁-C₈alkylsulfonyl-, C₁-C₈haloalkylsulfonyl-, C₁-C₈alkylaminosulfonyl, (C₁-C₈alkyl)₂aminosulfonyl-, C₁-C₈alkylcarbonyl-, C₁-C₈alkoxycarbonyl-, aryl or aryl substituted by one to five R¹⁵, heterocyclyl or heterocyclyl substituted by one to five R¹⁵, aryl-C₁-C₄alkylene or aryl-C₁-C₄alkylene wherein the aryl moiety is substituted by one to five R¹⁵, heterocyclyl-C₁-C₄alkylene or heterocyclyl-C₁-C₄alkylene wherein the heterocyclyl moiety is substituted by one to five R¹⁵, aryloxy or aryloxy substituted by one to five R¹⁵, aryloxy-C₁-C₄alkylene or aryloxy-C₁-C₄alkylene wherein the aryl moiety is substituted by one to five R¹⁵;

each R¹⁵ is independently halogen, cyano, nitro, C₁-C₄alkyl, C₁-C₄haloalkyl, C₁-C₄alkoxy-, or C₁-C₄haloalkoxy-;

each Z is independently halogen, C₁-C₁₂alkyl or C₁-C₁₂alkyl substituted by one to five R¹², nitro, C₁-C₁₂alkoxy or C₁-C₁₂alkoxy substituted by one to five R¹², cyano, C₁-C₁₂alkylsulfinyl, C₁-C₁₂alkylsulfonyl, C₁-C₁₂haloalkylsulfinyl, C₁-C₁₂haloalkylsulfonyl, hydroxyl or thiol.

The compounds of the invention may be applied as a non-repellent termiticide, e.g. the compound may be applied to create a termite barrier in which the compound is not uniformly applied along the barrier. For example, the barrier may include unintentional gaps in application of the compound, e.g. there may be one or more locations in the barrier at which the compound is not present at a lethal dose. In some cases there may be one or more locations in barrier at which the compound is not present, e.g. the chemical barrier may be discontinuous. This offers an important advantage over the repellent termiticides as it allows for a robust effect to be achieved under conditions that would be challenging and time consuming to achieve with repellent termiticides. Repellent termiticides must be applied carefully to ensure that there are no gaps.

The method may be for reducing the population of termites in a termite colony, e.g. a termite nest, comprising applying the compound of formula I at a location remote from the nest.

The method may comprise applying a compound of formula 1 to a first location to control termites at a second location, wherein the second location is remote from the first location, e.g. the method may comprise controlling termites at a second location by applying a compound of formula I to a first location, wherein the second location is remote from the first location. The non-repellency and slow action of the compounds of the invention may allow termites to pick up a lethal dose of compound and transfer the compound to other members of the colony, e.g. after traveling back to the nest. In other words, termites may be exposed to the compound that have not directly come into contact with the compound. With a sufficient number of termites transferring the compound back to the nest, ultimately the colony may be destroyed. Thus the amount of compound in the environment, e.g. in the soil, at the second location may be at sub-lethal levels, or even may be substantially zero, with control of the termite population at the second location arising from inter-termite transfer.

The second location may be the termite nest. The first location may be a location that is not the termite nest, e.g. an area of relatively low concentration of termites. The first location may be e.g. up to 1, 2, 5, 10, 15, 20, 25 or even up to 30 meters away from the nest.

The location where termite control is needed or is expected to be needed may be treated with a compound of formula I such that the concentration of compound at the location is sufficient to kill termites whilst allowing the termites to carry the compound of formula I away from the location of application, e.g. to the nest.

Suitably the compounds of the invention are applied as a liquid formulation, e.g. to soil, containing from 0.001% to 10% by weight of the compound of the invention, preferably from 0.005 to 5%, more preferably from 0.01% to 1%, in some cases 0.02 to 0.5% by weight of the compound of formula I. For example a liquid formulation for application, e.g. to soil, comprises at least 0.001%, preferably at least 0.005%, more preferably at least 0.01%, in some cases at least 0.02% by weight of the compound of formula I. A liquid formulation for application, e.g. to soil, may contain no more than 10%, preferably no more than 5%, more preferably no more than 1%, in some cases no more than 0.5% by weight of the compounds of the invention. In some cases liquid formulations for application, e.g. to soil, may contain no less than 0.01%, no less than 0.009, no less than 0.008, no less than 0.007, no less than 0.006, or no less than 0.005% by weight of the compounds of the invention. The termiticidal compositions of the invention generally contain the compounds of the invention in termiticidally effective amounts. The above values indicate the concentration of the formulation used on application, e.g. after dilution. The formulation prior to dilution may contain up to 75% by weight of the compound of formula I, e.g. 5% to 50%, usually 10% to 20% by weight.

Examples of rates are 1 g to 20 g per m² of compound of formula I, e.g. 5 g to 15 g per m², e.g. 7 g to 12 g per m². For example, no less than 0.5 g per m², no less than 1 g per m², e.g. no less than 5 g per m². For example no more than 20 g per m², no more than 15 g per m².

A termite nest is a structure that houses the termite colony, provides a protected living space and includes reproductive chambers. They are usually constructed from a combination of soil, mud and chewed wood/cellulose, saliva and faeces. Nests are commonly built underground, in large pieces of timber, inside fallen trees or on living trees. Some species of termite build nests above ground, which can develop into mounds. For the purposes of this invention the term nest is defined as the place where the reproductive termites and brood are to be found. The term “colony” describes the termites in a single population.

In one embodiment the invention provides a method for controlling, e.g. eradicating, the reproductive termites in a nest comprising applying a compound of formula 1 to a location remote from the nest.

The compounds of the invention are usually applied to soil, e.g. as a soil drench, but may also be applied to material comprising cellulose, e.g. wood. Other materials comprising cellulose include paper, cardboard, cloth, carpets.

In a further aspect the invention provides a method of protecting a man-made structure from infestation of termites comprising applying a compound of the invention in and/or around the structure, or in and/or around the area where the structure is to be located. The man-made structure will usually be a building, e.g. a building occupied by humans, in particular residential buildings. The compound may be incorporated into the building, in particular into the foundations of the building. The compound may also or alternatively be applied to the area where the building will be built, prior to or during construction. “Applying” a compound of formula I includes applying a bait comprising a compound of formula I.

The compounds of the invention may also be used in termite baits. A termite bait may be a material comprising substantially of cellulose, e.g. paper or card, and a compound of the invention. Suitable bait materials are known to the person skilled in the art. The compound may be applied to the bait after the bait is at the desired location and/or may be applied to the bait during construction, e.g. the cellulose material may be impregnated with a compound of the invention.

In a further aspect the invention provides a method for controlling termites comprising locating an, e.g. cellulose-based, termite bait comprising a compound of formula I where termite control is needed or is expected to be needed. In a further aspect the invention provides an, e.g. cellulose-based, termite bait comprising a compound of formula I.

The method may comprise locating a bait comprising a compound of formula 1 to a first location to control termites at a second location, wherein the second location is remote from the first location, e.g. the method may comprise controlling termites at a second location by locating a bait comprising a compound of formula I to a first location, wherein the second location is remote from the first location. The second location may be the termite nest. The first location may be a location that is not the termite nest, e.g. an area of relatively low concentration of termites. The first location may be e.g. up to 1, 2, 5, 10, 15, 20, 25 or even up to 30 meters away from the nest.

The location where termite control is needed or is expected to be needed may be treated with a compound of formula I such that the concentration of compound at the location is sufficient to kill termites whilst allowing the termites to carry the compound of formula I away from the location of application, e.g. to the nest.

Suitably the compounds of the invention are applied as a liquid formulation for use in baits containing from 0.0001% to 10% by weight of the compound of the invention, preferably from 0.0005 to 5% by weight, more preferably from 0.001% to 1% by weight of the compound of formula I. For example a liquid formulation for use in baits comprises at least 0.0001%, preferably at least 0.0005%, more preferably at least 0.001% by weight of the compound of formula I. In some cases the liquid formulation for use in baits may contain at least 0.01%, or at least 0.1% by weight of the compounds of the invention. A liquid formulation for use in baits may contain no more than 10%, preferably no more than 5%, more preferably no more than 1% by weight of the compounds of the invention. In some cases the liquid formulation for use in baits may contain no more than 0.1%, or no more than 0.01% by weight of the compounds of the invention.

In a further aspect the invention provides use of a compound of the invention as a non-repellent termiticide.

In a preferred embodiment the invention provides a method for controlling termites comprising applying a liquid formulation comprising a compound of formula IA to a location where termite control is needed or is expected to be needed, wherein the compound of formula IA is

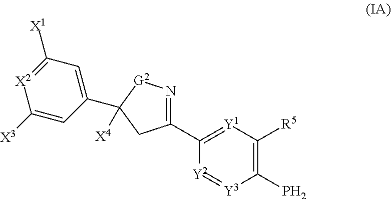

wherein P is P0

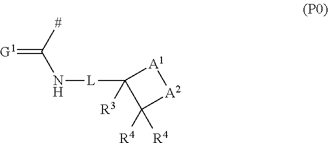

or P is selected from P1 to P54

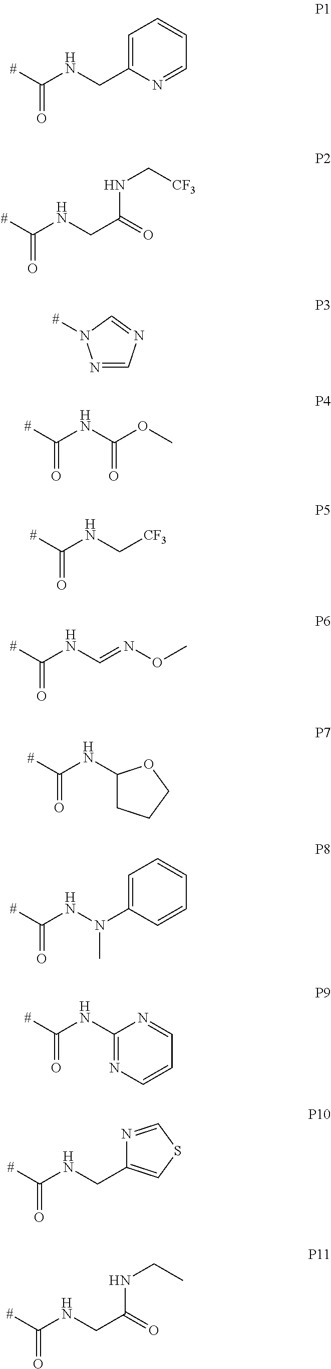

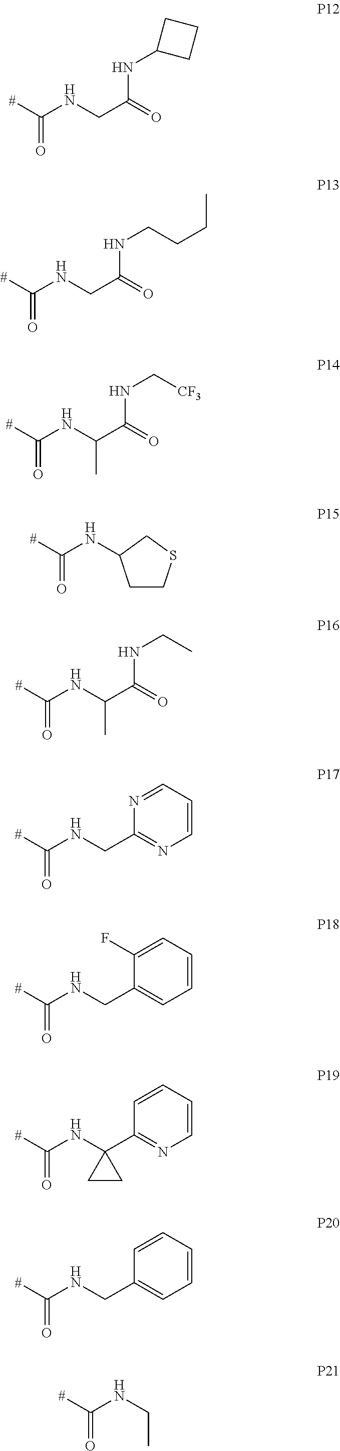

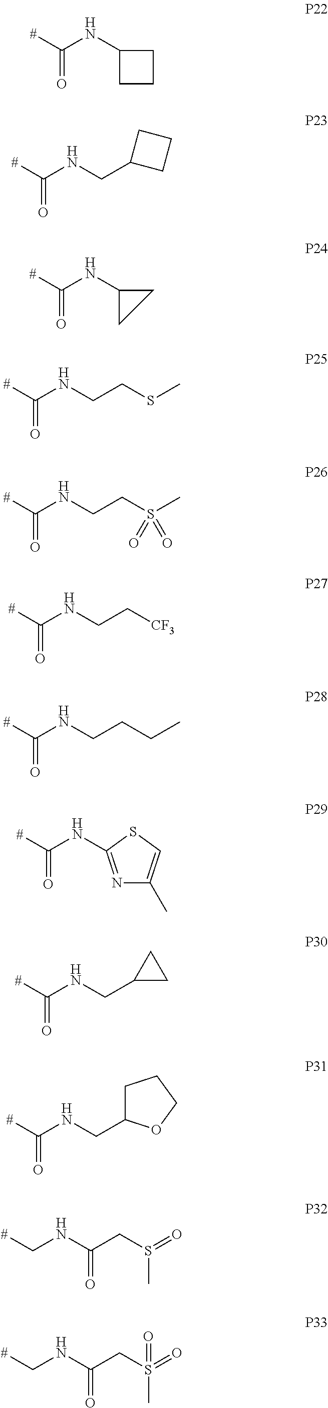

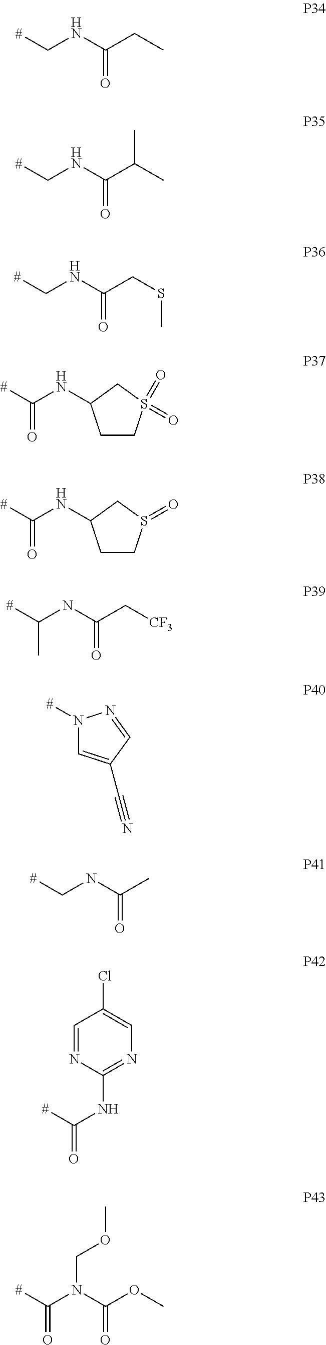

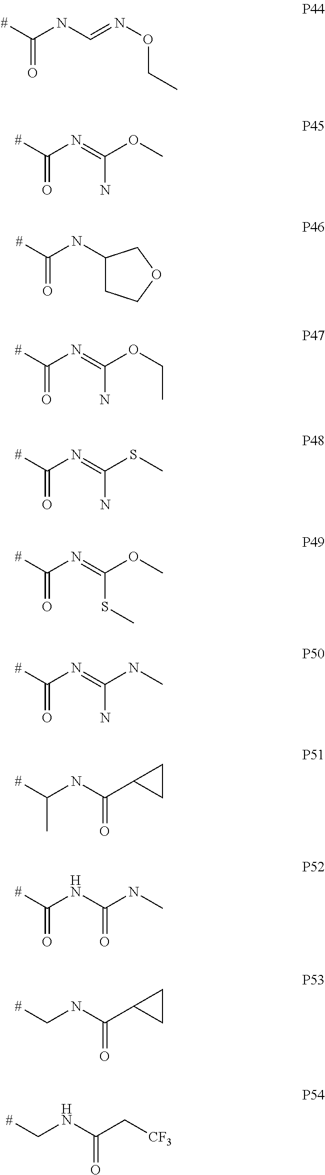

G¹ is oxygen;

### G² is O or CH₂;

L is a bond, methylene or ethylene;
one of A¹ and A² is S, SO or SO₂ and the other is —C(R⁴)R⁴—;
R³ is hydrogen or methyl;
each R⁴ is independently hydrogen or methyl;
Y¹ is C—R⁶, CH or nitrogen;
Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₂alkyl, C₁-C₂haloalkyl, C₃-C₅cycloalkyl, C₃-C₅halocycloalkyl, C₁-C₂alkoxy, C₁-C₂haloalkoxy;
R⁶ together with R⁵ forms a —CH═CH—CH═CH— bridge;
X² is C—X⁶ or nitrogen;
X¹, X³ and X⁶ are independently hydrogen, halogen or trihalomethyl, wherein at least two of
X¹, X³ and X⁶ are not hydrogen;
X⁴ is trifluoromethyl, difluoromethyl or chlorodifluoromethyl.
These compounds are described in WO2009/080250, WO2010/025998, WO2010/149506 and WO2011/054871 each of which is incorporated by reference.

Preferred values of P, G¹, G², A¹, A², R³, R⁴, X¹, X², X³, X⁴, X⁵ and X⁶ are in any combination, as set out below.

Preferably P is selected from P1, P2 and P55 to P64

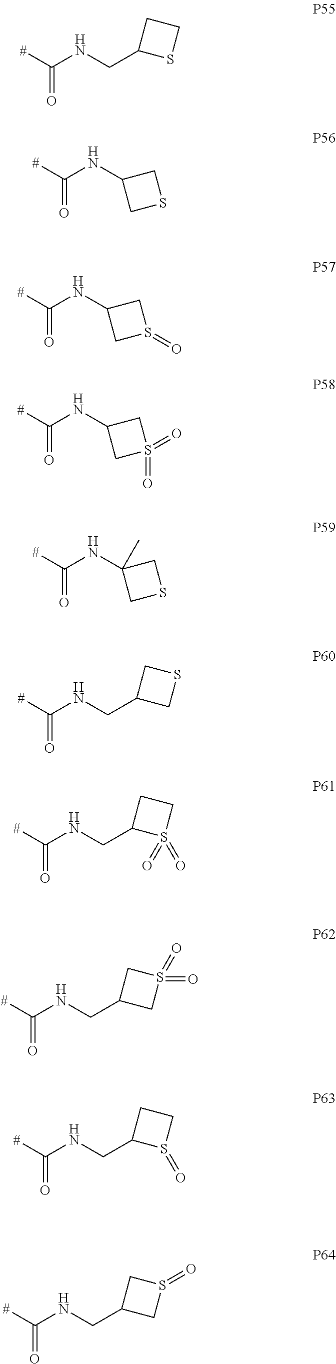

More preferably P is selected from P2 and P56, P57 and P58, more preferably P2 and P57, most preferably P57. In one group of compounds P is selected from P55 to P64. In another group of compounds P is selected from P56, P57 and P58.

Preferably R³ is hydrogen.

Preferably each R⁴ is hydrogen.

Preferably R⁵ is hydrogen, chloro, bromo, fluoro, trifluoromethyl, methyl, ethyl, methoxy, nitro, trifluoromethoxy, cyano, cyclopropyl, more preferably R⁵ is hydrogen, chloro, bromo, fluoro, trifluoromethyl, methyl, ethyl, nitro, cyano, cyclopropyl, even more preferably R⁵ is chloro, bromo, fluoro, methyl, trifluoromethyl, most preferably methyl.

Preferably G¹ is oxygen.

Preferably G² is oxygen.

Preferably L is a bond.

Preferably A¹ is —C(R⁴)R⁴—, more preferably —CH₂—.

Preferably A² is S, SO or SO₂.

Preferably Y¹ is CH, Y² is CH, Y³ is CH, or Y¹ is N, Y² is CH, Y³ is CH, or Y¹ is N, Y² is N, Y³ is CH, or Y¹ is CH, Y² is N, Y³ is CH, or Y¹ is CH, Y² is CH, Y³ is N. Preferably Y¹ is CH, Y² is CH, and Y³ is CH.

Preferably X¹, X³ and X⁶ are independently hydrogen, halogen or trifluoromethyl, wherein at least two of X¹, X³ and X⁶ are not hydrogen. More preferably X¹, X³ and X⁶ are independently hydrogen, chloro, bromo or trifluoromethyl, wherein at least two of X¹, X³ and X⁶ are not hydrogen. Preferably at least two of X¹, X³ and X⁶ are chloro, bromo or trifluoromethyl.

Preferably X² is C—X⁶;

Preferably X¹ is chloro, X² is CH, X³ is chloro, or X¹ is chloro, X² is C—F, X³ is hydrogen, or X¹ is fluoro, X² is C—Cl, X³ is hydrogen, or X¹ is chloro, X² is C—Cl, X³ is hydrogen, or X¹ is chloro, X² is C—Br, X³ is chloro, or X¹ is chloro, X² is C—F, X³ is chloro, or X¹ is chloro, X² is C—Cl, X³ is chloro, or X¹ is chloro, X² is C—I, X³ is chloro, or X¹ is fluoro, X² is C—F, X³ is fluoro, or X¹ is chloro, X² is CH, X³ is bromo, or X¹ is chloro, X² is CH, X³ is fluoro, or X¹ is chloro, X² is CH, X³ is trifluoromethyl, or X¹ is chloro, X² is C—Cl, X³ is trifluoromethyl, or X¹ is trifluoromethyl, X² is CH, X³ is trifluoromethyl, or X¹ is trifluoromethyl, X² is C—Cl, X³ is trifluoromethyl, or X¹ is trifluoromethyl, X² is CH, X³ is hydrogen, or X¹ is chloro, X² is N, X³ is chloro, or X¹ is trifluoromethyl, X² is N, X³ is trifluoromethyl. Most preferably X¹ is chloro, X² is CH, X³ is chloro.

Preferably X⁴ is trifluoromethyl, or chlorodifluoromethyl, more preferably trifluoromethyl.

In one group of compounds G² is oxygen.

In one group of compounds G² is CH₂.

In one group of compounds Y¹ is C—R⁶ and R⁶ together with R⁵ forms a —CH═CH—CH═CH— bridge.

In one group of compounds X² is C—X⁶, Y¹, Y² and Y³ are C—H, and R⁵ is chloro, bromo, methyl or trifluoromethyl.

In one group of compounds X² is C—X⁶, Y¹, Y² and Y³ are C—H, G¹ is oxygen, G² is oxygen, A¹ is CH₂, A² is S, SO or SO₂, L is a bond, R³ and each R⁴ is hydrogen, R⁵ is chloro, bromo, methyl or trifluoromethyl.

In another group of compounds X² is C—X⁶, Y¹, Y² and Y³ are C—H, G¹ is oxygen, G² is oxygen, A¹ is CH₂, A² is S, SO or SO₂, L is a bond, R³ and each R⁴ is hydrogen, R⁵ is chloro, bromo, methyl or trifluoro methyl, Y¹ is CH, Y² is CH, and Y³ is CH, X⁴ is trifluoromethyl.

In another group of compounds X² is C—X⁶, Y¹, Y² and Y³ are C—H, G¹ is oxygen, G² is oxygen, A¹ is CH₂, A² is S, SO or SO₂, L is a bond, R³ and each R⁴ is hydrogen, R⁵ is chloro, bromo, methyl or trifluoro methyl, Y¹ is CH, Y² is CH, and Y³ is CH, X⁴ is trifluoromethyl, X¹ is chloro, X² is CH, X³ is chloro.

Compounds of the invention may be prepared as described in WO2009/080250, WO2010/025998, WO2010/149506 and WO2011/054871 which methods are incorporated herein by reference.

Compounds of formula IA include at least one chiral centre and may exist as compounds of formula IA* or compounds of formula IA**.

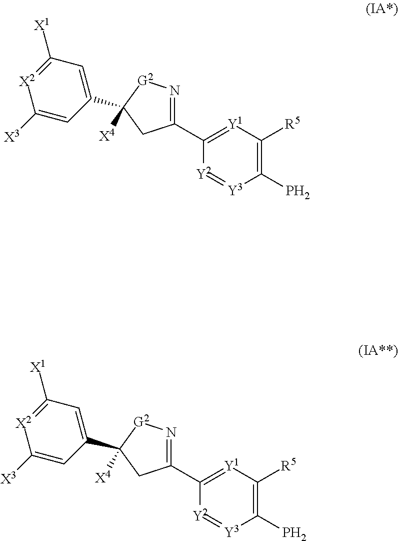

Compounds of formula IA** are more biologically active than compounds of formula IA*. The compound of formula IA may be a mixture of compounds IA* and IA** in any ratio e.g. in a molar ratio of 1:99 to 99:1, e.g. 10:1 to 1:10, e.g. a substantially 50:50 molar ratio. Preferably the compound of formula IA is a racemic mixture of the compounds of formula IA** and IA* or is enantiomerically enriched for the compound of formula IA**. For example, when the compound of formula IA is an enantiomerically enriched mixture of formula IA**, the molar proportion of compound IA** compared to the total amount of both enantiomers is for example greater than 50%, e.g. at least 55, 60, 65, 70, 75, 80, 85, 90, 95, 96, 97, 98, or at least 99%. Preferably the compound of formula IA is at least 90% enriched for the compound of formula IA**.

Where A¹ or A² is SO, the compound of formula IA may be a mixture of the cis and trans isomer in any ratio, e.g. in a molar ratio of 1:99 to 99:1, e.g. 10:1 to 1:10, e.g. a substantially 50:50 molar ratio. For example, in trans enriched mixtures of the compound of formula IA, e.g. when A¹ or A² is SO, the molar proportion of the trans compound in the mixture compared to the total amount of both cis and trans is for example greater than 50%, e.g. at least 55, 60, 65, 70, 75, 80, 85, 90, 95, 96, 97, 98, or at least 99%. Likewise, in cis enriched mixtures of the compound of formula IA (preferred), e.g. when A¹ or A² is SO, the molar proportion of the cis compound in the mixture compared to the total amount of both cis and trans is for example greater than 50%, e.g. at least 55, 60, 65, 70, 75, 80, 85, 90, 95, 96, 97, 98, or at least 99%. The compound of formula IA may be enriched for the trans sulphoxide. Likewise, the compound of formula IA may be enriched for the cis sulphoxide.

A selection of preferred compounds of formula IA are compounds 1 to 32 shown in Table A below.

TABLE A
Compounds of formula IA(a)
(Ia)

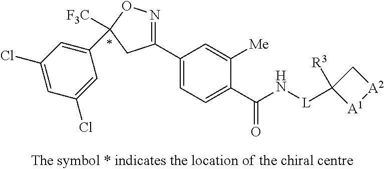

| Comp | Stereochemistry | | | | |
|---|---|---|---|---|---|
| No. | at * | L | R³ | A² | A¹ |
| 1 | racemic mixture | bond | CH₃ | S | CH₂ |
| 2 | racemic mixture | bond | CH₃ | SO (cis) | CH₂ |
| 3 | racemic mixture | bond | CH₃ | SO (trans) | CH₂ |
| 4 | racemic mixture | bond | CH₃ | SO₂ | CH₂ |
| 5 | racemic mixture | bond | H | S | CH₂ |
| 6 | racemic mixture | bond | H | SO (cis) | CH₂ |
| 7 | racemic mixture | bond | H | SO (trans) | CH₂ |
| 8 | racemic mixture | bond | H | SO₂ | CH₂ |
| 9 | racemic mixture | CH₂ | CH₃ | CH₂ | S |
| 10 | racemic mixture | CH₂ | CH₃ | CH₂ | SO (cis) |
| 11 | racemic mixture | CH₂ | CH₃ | CH₂ | SO (trans) |
| 12 | racemic mixture | CH₂ | CH₃ | CH₂ | SO₂ |
| 13 | racemic mixture | CH₂ | H | CH₂ | S |
| 14 | racemic mixture | CH₂ | H | CH₂ | SO (cis) |
| 15 | racemic mixture | CH₂ | H | CH₂ | SO (trans) |
| 16 | racemic mixture | CH₂ | H | CH₂ | SO₂ |
| 17 | as for IA** | bond | CH₃ | S | CH₂ |
| 18 | as for IA** | bond | CH₃ | SO (cis) | CH₂ |
| 19 | as for IA** | bond | CH₃ | SO (trans) | CH₂ |
| 20 | as for IA** | bond | CH₃ | SO₂ | CH₂ |
| 21 | as for IA** | bond | H | S | CH₂ |
| 22 | as for IA** | bond | H | SO (cis) | CH₂ |
| 23 | as for IA** | bond | H | SO (trans) | CH₂ |
| 24 | as for IA** | bond | H | SO₂ | CH₂ |
| 25 | as for IA** | CH₂ | CH₃ | CH₂ | S |
| 26 | as for IA** | CH₂ | CH₃ | CH₂ | SO (cis) |
| 27 | as for IA** | CH₂ | CH₃ | CH₂ | SO (trans) |
| 28 | as for IA** | CH₂ | CH₃ | CH₂ | SO₂ |
| 29 | as for IA** | CH₂ | H | CH₂ | S |
| 30 | as for IA** | CH₂ | H | CH₂ | SO (cis) |
| 31 | as for IA** | CH₂ | H | CH₂ | SO (trans) |
| 32 | as for IA** | CH₂ | H | CH₂ | SO₂ |
| 33 | As for IA* | bond | CH₃ | S | CH₂ |
| 34 | As for IA* | bond | CH₃ | SO (cis) | CH₂ |
| 35 | As for IA* | bond | CH₃ | SO (trans) | CH₂ |
| 36 | As for IA* | bond | CH₃ | SO₂ | CH₂ |
| 37 | As for IA* | bond | H | S | CH₂ |
| 38 | As for IA* | bond | H | SO (cis) | CH₂ |
| 39 | As for IA* | bond | H | SO (trans) | CH₂ |
| 40 | As for IA* | bond | H | SO₂ | CH₂ |
| 41 | As for IA* | CH₂ | CH₃ | CH₂ | S |
| 42 | As for IA* | CH₂ | CH₃ | CH₂ | SO (cis) |
| 43 | As for IA* | CH₂ | CH₃ | CH₂ | SO (trans) |
| 44 | As for IA* | CH₂ | CH₃ | CH₂ | SO₂ |
| 45 | As for IA* | CH₂ | H | CH₂ | S |
| 46 | As for IA* | CH₂ | H | CH₂ | SO (cis) |
| 47 | As for IA* | CH₂ | H | CH₂ | SO (trans) |
| 48 | As for IA* | CH₂ | H | CH₂ | SO₂ |

I** refers to a compound of formula IA**,
IA* refers to a compound of formula IA*

TABLE B
Compounds of formula IB(a)
(Ib)

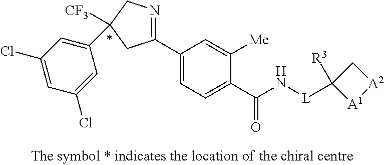

| Comp | Stereochemistry | | | | |
|---|---|---|---|---|---|
| No. | at * | L | R³ | A² | A¹ |
| 1b | racemic mixture | bond | CH₃ | S | CH₂ |
| 2b | racemic mixture | bond | CH₃ | SO (cis) | CH₂ |
| 3b | racemic mixture | bond | CH₃ | SO (trans) | CH₂ |
| 4b | racemic mixture | bond | CH₃ | SO₂ | CH₂ |
| 5b | racemic mixture | bond | H | S | CH₂ |
| 6b | racemic mixture | bond | H | SO (cis) | CH₂ |
| 7b | racemic mixture | bond | H | SO (trans) | CH₂ |
| 8b | racemic mixture | bond | H | SO₂ | CH₂ |
| 9b | racemic mixture | CH₂ | CH₃ | CH₂ | S |
| 10b | racemic mixture | CH₂ | CH₃ | CH₂ | SO (cis) |
| 11b | racemic mixture | CH₂ | CH₃ | CH₂ | SO (trans) |
| 12b | racemic mixture | CH₂ | CH₃ | CH₂ | SO₂ |
| 13b | racemic mixture | CH₂ | H | CH₂ | S |
| 14b | racemic mixture | CH₂ | H | CH₂ | SO (cis) |
| 15b | racemic mixture | CH₂ | H | CH₂ | SO (trans) |
| 16b | racemic mixture | CH₂ | H | CH₂ | SO₂ |
| 17b | as for IA** | bond | CH₃ | S | CH₂ |
| 18b | as for IA** | bond | CH₃ | SO (cis) | CH₂ |
| 19b | as for IA** | bond | CH₃ | SO (trans) | CH₂ |
| 20b | as for IA** | bond | CH₃ | SO₂ | CH₂ |
| 21b | as for IA** | bond | H | S | CH₂ |
| 22b | as for IA** | bond | H | SO (cis) | CH₂ |
| 23b | as for IA** | bond | H | SO (trans) | CH₂ |
| 24b | as for IA** | bond | H | SO₂ | CH₂ |
| 25b | as for IA** | CH₂ | CH₃ | CH₂ | S |
| 26b | as for IA** | CH₂ | CH₃ | CH₂ | SO (cis) |
| 27b | as for IA** | CH₂ | CH₃ | CH₂ | SO (trans) |
| 28b | as for IA** | CH₂ | CH₃ | CH₂ | SO₂ |
| 29b | as for IA** | CH₂ | H | CH₂ | S |
| 30b | as for IA** | CH₂ | H | CH₂ | SO (cis) |
| 31b | as for IA** | CH₂ | H | CH₂ | SO (trans) |
| 32b | as for IA** | CH₂ | H | CH₂ | SO₂ |
| 33b | As for IA* | bond | CH₃ | S | CH₂ |
| 34b | As for IA* | bond | CH₃ | SO (cis) | CH₂ |
| 35b | As for IA* | bond | CH₃ | SO (trans) | CH₂ |
| 36b | As for IA* | bond | CH₃ | SO₂ | CH₂ |
| 37b | As for IA* | bond | H | S | CH₂ |
| 38b | As for IA* | bond | H | SO (cis) | CH₂ |
| 39b | As for IA* | bond | H | SO (trans) | CH₂ |
| 40b | As for IA* | bond | H | SO₂ | CH₂ |
| 41b | As for IA* | CH₂ | CH₃ | CH₂ | S |
| 42b | As for IA* | CH₂ | CH₃ | CH₂ | SO (cis) |
| 43b | As for IA* | CH₂ | CH₃ | CH₂ | SO (trans) |
| 44b | As for IA* | CH₂ | CH₃ | CH₂ | SO₂ |
| 45b | As for IA* | CH₂ | H | CH₂ | S |
| 46b | As for IA* | CH₂ | H | CH₂ | SO (cis) |
| 47b | As for IA* | CH₂ | H | CH₂ | SO (trans) |
| 48b | As for IA* | CH₂ | H | CH₂ | SO₂ |

I** refers to a compound of formula IA**,
IA* refers to a compound of formula IA*

One embodiment provides a mixture of compounds 21 and 37 wherein the mixture contains at least 70 mol % of compound 21 compared to the total amount of compound 21 and 37. Preferably the mixture contains at least 80 mol %, preferably at least 90 mol %, even more preferably at least 95 mol % of compound 21 compared to the total amount of compound 21 and 37.

A further embodiment provides a mixture of compounds 22, 23, 38 and 39 wherein the mixture contains at least 70 mol % of compounds 22 and 23 compared to the total amount of compounds 22, 23, 38 and 39. Preferably the mixture contains at least 80 mol %, preferably at least 90 mol %, even more preferably at least 95 mol % of compounds 22 and 23 compared to the total amount of compounds 22, 23, 38 and 39. Preferably the mixture also contains at least 60 mol % of compounds 22 and 38 compared to the total amount of 22, 23, 38 and 39, more preferably 70 mol %, even more preferably 80 mol % of compounds 22 and 38 compared to the total amount of compounds 22, 23, 38 and 39. For example the mixture may contain at least 90 mol % of compounds 22 and 23 compared to the total amount of compounds 22, 23, 38 and 39 and at least 60 mol % of compounds 22 and 38 compared to the total amount of compounds 22, 23, 38 and 39, for example the mixture may contain at least 90 mol % of compounds 22 and 23 and at least 70 mol % of compounds 22 and 38, for example the mixture may contain at least 90 mol % of compounds 22 and 23 and at least 80 mol % of compounds 22 and 38, for example the mixture may contain at least 90 mol % of compounds 22 and 23 and at least 90 mol % of compounds 22 and 38 compared to the total amount of compounds 22, 23, 38 and 39.

A further embodiment provides a mixture of compounds 24 and 40 wherein the mixture contains at least 70 mol % of compound 24 compared to the total amount of compound 24 and 40. Preferably the mixture contains at least 80 mol %, preferably at least 90 mol %, even more preferably at least 95 mol % of compound 24 compared to the total amount of compound 24 and 40.

Compounds of formula IAb are also preferred compounds of the invention.

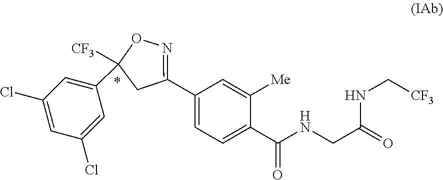 [SMILES: Cc1cc(C2=NOC(c3cc(Cl)cc(Cl)c3)(C(F)(F)F)C2)ccc1C(=O)NCC(=O)NCC(F)(F)F]

Compounds of formula IAb in which the stereo-configuration at * is S are particularly preferred.

Compounds of formula IAc are also preferred compounds of the invention.

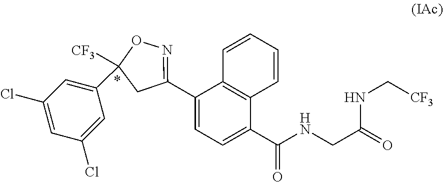 [SMILES: O=C(CNC(=O)c1ccc(C2=NOC(c3cc(Cl)cc(Cl)c3)(C(F)(F)F)C2)c2ccccc12)NCC(F)(F)F]

Compounds of formula IAc in which the stereo-configuration at * is S are particularly preferred.

In another preferred embodiment the compound of formula I is a compound of formula IB

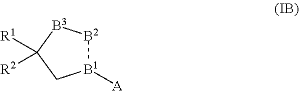

wherein —B¹-B²-B³— is —C═N—O—, —C═N—CH₂—, or —N—CH₂—CH₂—;
R¹ is trifluoromethyl, difluoromethyl or chlorodifluoromethyl;
R² is group X

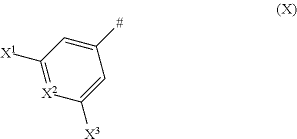

X² is C—X⁶ or nitrogen;
X¹, X³ and X⁶ are independently hydrogen, halogen or trihalomethyl, wherein at least one of
X¹, X³ and X⁶ is not hydrogen;
A is selected from group A1 to A5

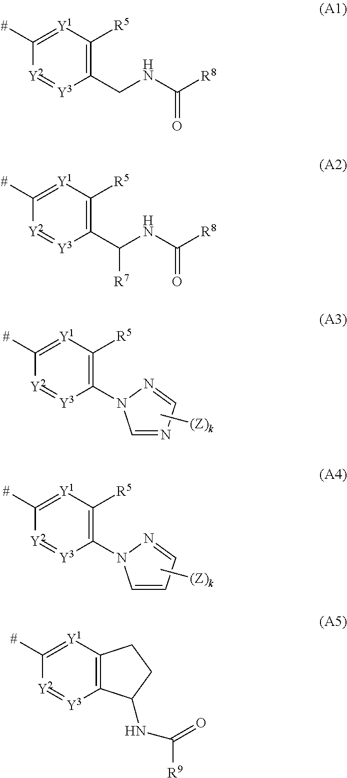

Y¹ is C—R⁶, CH or nitrogen;
Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₄alkyl, C₁-C₄haloalkyl, C₃-C₅cycloalkyl, C₃-C₅halocycloalkyl, C₁-C₂alkoxy, or C₁-C₂haloalkoxy;
R⁶ when present together with R⁵ forms a —CH═CH—CH═CH— bridge;
R⁷ is C₁-C₄alkyl;
R⁸ is C₁-C₄alkyl, C₁-C₄haloalkyl, C₁-C₄alkoxy(C₁-C₄)alkyl, C₁-C₄alkylthio(C₁-C₄)alkyl, C₁-C₄alkylsulfinyl(C₁-C₄)alkyl, C₁-C₄alkylsulfonyl(C₁-C₄)alkyl, C₃-C₆cycloalkyl, C₃-C₆cycloalkyl(C₁-C₄)alkyl-, or tetrahydrofuranyl;
R⁹ is C₁-C₄alkyl, C₁-C₄haloalkyl, C₁-C₄alkyl-O—CH₂—, C₁-C₄haloalkyl-O—CH₂—, C₃-C₆cycloalkyl, or C₃-C₆cycloalkyl-CH₂—, C₁-C₄alkyl-S—CH₂—, C₁-C₄alkyl-S(O)—CH₂—, C₁-C₄alkyl-S(O₂)—CH₂;
each Z is independently halogen, C₁-C₁₂alkyl or C₁-C₁₂alkyl substituted by one to five R¹², nitro, C₁-C₁₂alkoxy or C₁-C₁₂alkoxy substituted by one to five R¹², cyano, C₁-C₁₂alkylsulfinyl, C₁-C₁₂alkylsulfonyl, C₁-C₁₂haloalkylsulfinyl, C₁-C₁₂haloalkylsulfonyl, hydroxyl or thiol;
each R¹² is halogen, cyano, nitro, hydroxy, C₁-C₈alkoxy-, C₁-C₈haloalkoxy-, mercapto, C₁-C₈alkylthio-, or C₁-C₈haloalkylthio; and
k is 0, 1, 2 or 3.

The preferences for B¹, B², B³, R¹, R², Y¹, Y², Y³, R⁵, R⁶, R⁷, R⁸, R⁹, R¹², X¹X², X³, Z and k are, in any combination, as described below.

Preferably R¹ is trifluoromethyl, or chlorodifluoromethyl, most preferably trifluoromethyl.

Preferably X¹, X³ and X⁶ are independently hydrogen, halogen or trifluoromethyl, wherein at least two of X¹, X³ and X⁶ are not hydrogen. More preferably X¹, X³ and X⁶ are independently hydrogen, chloro, bromo or trifluoromethyl, wherein at least two of X¹, X³ and X⁶ are not hydrogen. Preferably at least two of X¹, X³ and X⁶ are chloro, bromo or trifluoromethyl.

In one group of compounds R² is 3,5-dichlorophenyl-, 3-chloro-4-fluorophenyl-, 3-fluoro-4-chlorophenyl-, 3,4-dichlorophenyl-, 3-chloro-4-bromophenyl-, 3,5-dichloro-4-fluorophenyl-, 3,4,5-trichlorophenyl-, 3,5-dichloro-4-iodophenyl-, 3,4,5-trifluorophenyl-, 3-chloro-5-bromophenyl-, 3-chloro-5-fluorophenyl-, 3-chloro-5-(trifluoromethyl)phenyl-, 3,4-dichloro-5-(trifluoromethyl)phenyl-, 3,5-bis(trifluoromethyl)phenyl-, 4-chloro-3,5-bis(trifluoromethyl)phenyl-, 3-(trifluoromethyl)phenyl-, 2,6-dichloro-4-pyridyl-, 2,6-bis(trifluoromethyl)-4-pyridyl-, more preferably 3,5-dichlorophenyl-, more preferably 3-chloro-5-bromophenyl-, 3-chloro-5-(trifluoromethyl)phenyl-, 3,5-dichloro-4-fluorophenyl-, 3,4,5-trichlorophenyl-, 3,5-bis(trifluoromethyl)phenyl-, 3-(trifluoromethyl)phenyl-, 2,6-dichloro-4-pyridyl-, 2,6-bis(trifluoromethyl)-4-pyridyl-, 3,5-dichloro-4-bromophenyl-, 3-bromo-5-(trifluoromethyl)phenyl-, 3,5-dibromophenyl-, or 3,4-dichlorophenyl-, more preferably R² is 3,5-dichloro-phenyl, 3,5-dichloro-4-fluorophenyl- or 3,4,5-trichloro-phenyl, most preferably 3,5-dichloro-phenyl.

Preferably Y¹ is CH, Y² is CH, Y³ is CH, or Y¹ is N, Y² is CH, Y³ is CH, or Y¹ is N, Y² is N, Y³ is CH, or Y¹ is CH, Y² is N, Y³ is CH, or Y¹ is CH, Y² is CH, Y³ is N. Most preferably Y¹ is CH, Y² is CH, and Y³ is CH.

Preferably R⁵ is hydrogen, chloro, bromo, fluoro, trifluoromethyl, methyl, ethyl, methoxy, nitro, trifluoromethoxy, cyano, cyclopropyl, more preferably R⁵ is hydrogen, chloro, bromo, fluoro, trifluoromethyl, methyl, ethyl, nitro, cyano, cyclopropyl, most preferably R⁵ is hydrogen, cyano, chloro, bromo, fluoro, methyl, or trifluoromethyl.

Preferably R⁸ is C₁-C₄alkyl, C₁-C₄haloalkyl, C₁-C₄alkyl-O—CH₂—, C₁-C₄haloalkyl-O—CH₂—, C₃-C₆cycloalkyl, C₃-C₆cycloalkyl-CH₂—, C₁-C₄alkyl-S(O)—CH₂—, C₁-C₄alkyl-S(O₂)—CH₂—, more preferably C₁-C₄alkyl, C₁-C₄alkyl-O—CH₂—, C₁-C₄alkyl-S—CH₂—, C₁-C₄alkyl-SO—CH₂—, C₁-C₄alkyl-SO₂—CH₂—, C₃-C₄cycloalkyl, or C₃-C₄cycloalkyl-CH₂—, most preferably R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

Preferably R⁹ is C₁-C₄alkyl, C₁-C₄haloalkyl, C₁-C₄alkyl-O—CH₂—, C₁-C₄haloalkyl-O—CH₂—, C₃-C₆cycloalkyl, C₃-C₆cycloalkyl-CH₂—, C₁-C₄alkyl-S(O)—CH₂—, C₁-C₄alkyl-S(O₂)—CH₂—, more preferably C₁-C₄alkyl, C₁-C₄haloalkyl, C₁-C₄alkyl-O—CH₂—, C₁-C₄haloalkyl-O—CH₂—, C₃-C₆cycloalkyl, C₃-C₆cycloalkyl-CH₂—, more preferably C₁-C₄alkyl, C₁-C₄haloalkyl or C₃-C₄cycloalkyl, more preferably methyl, ethyl, propyl, CF₃CH₂— or cyclopropyl, even more preferably ethyl, CF₃CH₂— or cyclopropyl.

Preferably each Z is independently halogen, cyano, C₁-C₄alkyl, C₁-C₄haloalkyl, C₁-C₄alkoxy, or C₁-C₄haloalkoxy, most preferably each Z is independently hydrogen, cyano, halogen, methyl, halomethyl, methoxy or halomethoxy, most preferably cyano or trifluoromethyl.

Each R¹² is preferably bromo, chloro, fluoro, methoxy, or methylthio, most preferably chloro, fluoro, or methoxy

Preferably k is 0 or 1.

In one group of compounds —B¹-B²-B³— is —C═N—O—.

In another group of compounds —B¹-B²-B³— is —C═N—CH₂—.

In another group of compounds —B¹-B²-B³— is —N—CH₂—CH₂—.

In another group of compounds Y¹ is C—R⁶ and R⁶ together with R⁵ forms a —CH═CH—CH═CH— bridge.

In one embodiment the compound of formula I is a compound of formula IA

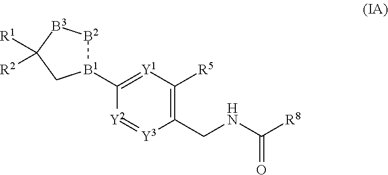

wherein B¹, B², B³, R¹, R², Y¹, Y², Y³, R⁵ and R⁸ are as defined for a compound of formula I

In compounds of formula IA preferred definitions of B¹, B², B³, R¹, R², Y¹, Y², Y³, R⁵ and R⁸ are, in any combination, as set out below:

Preferably R¹ is trifluoromethyl, or chlorodifluoromethyl, most preferably trifluoromethyl.

Preferably X¹, X³ and X⁶ are independently hydrogen, halogen or trifluoromethyl, wherein at least two of X¹, X³ and X⁶ are not hydrogen. More preferably X¹, X³ and X⁶ are independently hydrogen, chloro, bromo or trifluoromethyl, wherein at least two of X¹, X³ and X⁶ are not hydrogen. Preferably at least two of X¹, X³ and X⁶ are chloro, bromo or trifluoromethyl.

In one group of compounds R² is 3,5-dichlorophenyl-, 3-chloro-4-fluorophenyl-, 3-fluoro-4-chlorophenyl-, 3,4-dichlorophenyl-, 3-chloro-4-bromophenyl-, 3,5-dichloro-4-fluorophenyl-, 3,4,5-trichlorophenyl-, 3,5-dichloro-4-iodophenyl-, 3,4,5-trifluorophenyl-, 3-chloro-5-bromophenyl-, 3-chloro-5-fluorophenyl-, 3-chloro-5-(trifluoromethyl)phenyl-, 3,4-dichloro-5-(trifluoromethyl)phenyl-, 3,5-bis(trifluoromethyl)phenyl-, 4-chloro-3,5-bis(trifluoromethyl)phenyl-, 3-(trifluoromethyl)phenyl-, 2,6-dichloro-4-pyridyl-, 2,6-bis(trifluoromethyl)-4-pyridyl-, more preferably 3,5-dichlorophenyl-, more preferably 3-chloro-5-bromophenyl-, 3-chloro-5-(trifluoromethyl)phenyl-, 3,5-dichloro-4-fluorophenyl-, 3,4,5-trichlorophenyl-, 3,5-bis(trifluoromethyl)phenyl-, 3-(trifluoromethyl)phenyl-, 2,6-dichloro-4-pyridyl-, 2,6-bis(trifluoromethyl)-4-pyridyl-, 3,5-dichloro-4-bromophenyl-, 3-bromo-5-(trifluoromethyl)phenyl-, 3,5-dibromophenyl-, or 3,4-dichlorophenyl-, more preferably R² is 3,5-dichloro-phenyl or 3,4,5-trichloro-phenyl, most preferably 3,5-dichloro-phenyl.

Preferably Y¹ is CH, Y² is CH, Y³ is CH, or Y¹ is N, Y² is CH, Y³ is CH, or Y¹ is N, Y² is N, Y³ is CH, or Y¹ is CH, Y² is N, Y³ is CH, or Y¹ is CH, Y² is CH, Y³ is N. Most preferably Y¹ is CH, Y² is CH, and Y³ is CH.

Preferably R⁵ is hydrogen, chloro, bromo, fluoro, trifluoromethyl, methyl, ethyl, methoxy, nitro, trifluoromethoxy, cyano, cyclopropyl, more preferably R⁵ is hydrogen, chloro, bromo, fluoro, trifluoromethyl, methyl, ethyl, nitro, cyano, cyclopropyl, more preferably R⁵ is hydrogen, cyano, chloro, bromo, fluoro, methyl, or trifluoromethyl, even more preferably hydrogen, chloro, bromo, methyl or trifluoromethyl, most preferably chloro, bromo, fluoro or methyl.

Preferably R⁸ is C₁-C₄alkyl, C₁-C₄haloalkyl, C₁-C₄alkyl-O—CH₂—, C₁-C₄haloalkyl-O—CH₂—, C₃-C₆cycloalkyl, C₃-C₆cycloalkyl-CH₂—, C₁-C₄alkyl-S(O)—CH₂—, C₁-C₄alkyl-S(O₂)—CH₂—, more preferably C₁-C₄alkyl, C₁-C₄alkyl-O—CH₂—, C₁-C₄alkyl-S—CH₂—, C₁-C₄alkyl-SO—CH₂—, C₁-C₄alkyl-SO₂—CH₂—, C₃-C₄cycloalkyl, or C₃-C₄cycloalkyl-CH₂—, most preferably R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In one group of compounds of formula IA —B¹-B²-B³— is —C═N—O—.

In another group of compounds of formula IA —B¹-B²-B³— is —C═N—O— and Y¹ is CH, Y² is CH, Y³ is CH.

In another group of compounds of formula IA —B¹-B²-B³— is —C═N—O—, Y¹ is CH, Y² is CH, Y³ is CH and R¹ is CF₃.

In another group of compounds of formula IA —B¹-B²-B³— is —C═N—O—, Y¹ is CH, Y² is CH, Y³ is CH, R¹ is CF₃ and R⁵ is chloro, bromo, fluoro or methyl.

In another group of compounds of formula IA —B¹-B²-B³— is —C═N—O—, Y¹ is CH, Y² is CH, Y³ is CH, R¹ is CF₃, and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —C═N—O—, Y¹ is CH, Y² is CH, Y³ is CH, R¹ is CF₃, R⁵ is chloro, bromo, fluoro or methyl and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —C═N—O—, Y¹ is CH, Y² is CH, Y³ is CH, R¹ is CF₃, R⁵ is chloro, bromo, fluoro or methyl, R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂— and R² is 3-chloro-5-bromophenyl-, 3-chloro-5-(trifluoromethyl)phenyl-, 3,5-dichloro-4-fluorophenyl-, 3,4,5-trichlorophenyl-, 3,5-bis(trifluoromethyl)phenyl-, 3-(trifluoromethyl)phenyl-, 2,6-dichloro-4-pyridyl-, 2,6-bis(trifluoromethyl)-4-pyridyl-, 3,5-dichloro-4-bromophenyl-, 3-bromo-5-(trifluoromethyl)phenyl-, 3,5-dibromophenyl-, or 3,4-dichlorophenyl-.

In one group of compounds of formula IA —B¹-B²-B³— is —C═N—CH₂—.

In another group of compounds of formula IA —B¹-B²-B³— is —C═N—CH₂— and Y¹ is CH, Y² is CH, Y³ is CH.

In another group of compounds of formula IA —B¹-B²-B³— is —C═N—CH₂—, Y¹ is CH, Y² is CH, Y³ is CH and R¹ is CF₃.

In another group of compounds of formula IA —B¹-B²-B³— is —C═N—CH₂—, Y¹ is CH, Y² is CH, Y³ is CH, R¹ is CF₃ and R⁵ is chloro, bromo, fluoro or methyl.

In another group of compounds of formula IA —B¹-B²-B³— is —C═N—CH₂—, Y¹ is CH, Y² is CH, Y³ is CH, R¹ is CF₃, and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —C═N—CH₂—, Y¹ is CH, Y² is CH, Y³ is CH, R¹ is CF₃, R⁵ is chloro, bromo, fluoro or methyl and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —C═N—CH₂—, Y¹ is CH, Y² is CH, Y³ is CH, R¹ is CF₃, R⁵ is chloro, bromo, fluoro or methyl and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂— and R² is 3-chloro-5-bromophenyl-, 3-chloro-5-(trifluoromethyl)phenyl-, 3,5-dichloro-4-fluorophenyl-, 3,4,5-trichlorophenyl-, 3,5-bis(trifluoromethyl)phenyl-, 3-(trifluoromethyl)phenyl-, 2,6-dichloro-4-pyridyl-, 2,6-bis(trifluoromethyl)-4-pyridyl-, 3,5-dichloro-4-bromophenyl-, 3-bromo-5-(trifluoromethyl)phenyl-, 3,5-dibromophenyl-, or 3,4-dichlorophenyl-

In one group of compounds of formula IA —B¹-B²-B³— is —N—CH₂—CH₂—.

In another group of compounds of formula IA —B¹-B²-B³— is —N—CH₂—CH₂—, Y¹ is CH, Y² is CH, Y³ is CH.

In another group of compounds of formula IA —B¹-B²-B³— is —N—CH₂—CH₂—, Y¹ is CH, Y² is CH, Y³ is CH and R¹ is CF₃.

In another group of compounds of formula IA —B¹-B²-B³— is —N—CH₂—CH₂—, Y¹ is CH, Y² is CH, Y³ is CH, R¹ is CF₃ and R⁵ is chloro, bromo, fluoro or methyl.

In another group of compounds of formula IA —B¹-B²-B³— is —N—CH₂—CH₂—, Y¹ is CH, Y² is CH, Y³ is CH, R¹ is CF₃, and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —N—CH₂—CH₂—, Y¹ is CH, Y² is CH, Y³ is CH, R¹ is CF₃, R⁵ is chloro, bromo, fluoro or methyl and R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA —B¹-B²-B³— is —N—CH₂—CH₂—, Y¹ is CH, Y² is CH, Y³ is CH, R¹ is CF₃, R⁵ is chloro, bromo, fluoro or methyl, R⁸ is methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂— and R² is 3-chloro-5-bromophenyl-, 3-chloro-5-(trifluoromethyl)phenyl-, 3,5-dichloro-4-fluorophenyl-, 3,4,5-trichlorophenyl-, 3,5-bis(trifluoromethyl)phenyl-, 3-(trifluoromethyl)phenyl-, 2,6-dichloro-4-pyridyl-, 2,6-bis(trifluoromethyl)-4-pyridyl-, 3,5-dichloro-4-bromophenyl-, 3-bromo-5-(trifluoromethyl)phenyl-, 3,5-dibromophenyl-, or 3,4-dichlorophenyl-

In another group of compounds of formula IA R⁵ is chloro, bromo, fluoro or methyl and

R⁸ methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—.

In another group of compounds of formula IA R⁵ is chloro, bromo, fluoro or methyl; R⁸ methyl, ethyl, isopropyl, CH₃—O—CH₂—, CH₃—S—CH₂—, CH₃—S(O)—CH₂—, CH₃—SO₂—CH₂—, cyclobutyl, cyclopropyl or cyclopropyl-CH₂—, R¹ is CF₃, —B¹-B²-B³ is —C═N—O— or —C═N—CH₂—, Y¹, Y² and Y³ are CH, and R⁵ is chloro or methyl.

Non-limiting examples of termites which may be controlled by compounds of the invention include Reticulitermes, Coptotermes, Macrotermes, Microtermes, Globitermes. Specific of subterranean termites include Reticulitermes flavipes, Reticulitermes hesperus, Reticulitermes verginicus, Reticulitermes hageni, Reticulitermes speratus, Reticulitermes lucifugus, Heterotermes aureus, Coptotermes formosanus, Coptotermes acinaciformis, Coptotermes curvignathus, Nasutitermes exitiosus, Nasutitermes walkeri, Mastotermes darwiniensis, Schedorhinotermes spp, Macrotermes bellicosus, Macrotermes spp., Globitermes sulphureus, Odontotermes spp. Specific examples of dry wood termites include Incisitermes minor, Marginitermes hubbardi, Cryptotermes brevis, Kalotermes flavicollis.

The formulations of the invention may contain formulation ingredients such as carriers, additives, surfactants etc., as is known to the person skilled in the art.

By the term “carrier” is meant an organic or inorganic material, which can be natural or synthetic, and which is associated with the active ingredient and which facilitates its application to the locus to be treated. This carrier is thus generally inert and should be accpetable for use on the contemplated or treated locus. The carrier can be solid (clay, silicates, silica, limestone, gypsum, ceramics, resins, wax, fertilizers, etc.) or liquid (water, alcohols, ketones, oil solvents, saturated or unsaturated hydrocarbons, chlorinated hydrocarbons, liquified petroleum gas, etc.).

Among the many additives, the compositions of the invention can comprise surfactants as well as other ingredients such as dispersants, stickers, antifoam agents, antifreezing agents, dyestuffs, thickeners, adhesives, protective colloids, penetrating agents, stabilizing agents, sequestering agents, antiflocculating agents, corrosion inhibitors, pigments and polymers. More generally, the compositions of the invention can contain all kinds of solid or liquid additives which are known in the art of insecticides and insecticidal treatments.

Surfactants can be of the emulsifying or wetting type, ionic or non-ionic. Possible surfactants are salts of polyacrylic or lignosulfonic acids; salts of phenolsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. When the spraying vehicle is water, the use of at least one surfactant is often desirable.

Bait may include nutritional feeding stimulants, e.g., fatty acids, amino acids, sugars, carbohydrates, pectins, starches, salts, chitins, essential plant oils and the like. Baits may also include attractants, e.g. a mixture of hydrocarbon compounds chosen as being alkanes or alkenes comprising from 20 to 40 carbon atoms as described in US2009010979, which is incorporated herein by reference. Termite baits are often applied within bait stations that protect the bait from non-target organisms (including children), the environment, etc., yet allow access to termites.

Solid compositions can be powders for dusting or for dispersion and granules, especially extruded, agglomerated or compacted granules, or granules which have been made by impregnation of a powder. Liquid compositions or compositions which have to be liquid or dispersed in a liquid when applied include solutions, water-soluble concentrates, emulsifiable concentrates, suspensions, suspension concentrates, suspoemulsions, emulsions, wettable powders or pastes or water-dispersible granules. In order to obtain these wettable powders or dusting powders, it is appropriate to intimately mix the active ingredients and the additives, as by grinding in a mill or similar device. Dispersible granules are generally made by agglomeration of a powder, followed by an appropriate granulation process. The emulsions herein described can be of the oil-in-water or water-in-oil types. Fluidity of the emulsions can range from low viscosities up to high viscosities approaching those of gels. Among these many compositions or formulations, one skilled in the art can choose the one most appropriate, according to the specific conditions of the treatment problem.

The present invention relates to methods of controlling ants and in particular to methods of controlling ants using compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings.

Ants are considered to be nuisance pests in the home. In addition, some species of ants, such as leaf cutter ants can cause significant damage to crops, as well as damaging farmland and roads with their nest making activities. Control of ants can be accomplished by application of an insecticide to surfaces where ant activity occurs, or via the use of ant baits.

When insecticides are used to control ants it is highly desirable that the insecticide is not repellent to the ants. Application of an insecticide that is repellent will not be effective because the ants will simply avoid the insecticide. With a non-repellant insecticide, the ants will be much slower to avoid the insecticide and may pick up the insecticide and transfer it to the nest. In other words, non-repellency is needed for an insecticide to be an effective formicide. Many insecticides that kill ants are not suitable for use in ant baits because they do not have the property of non-repellency. It is also desirable that a formicide is effective at low rates to minimise environmental impact. Fipronil and imidacloprid are examples of insecticides that are not repellant to ants.

Compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings, represent a new class of pesticides that are described for example in Ozoe et al. Biochemical and Biophysical Research Communications, 391 (2010) 744-749. Compounds from this class are broadly described in WO 2005/085216 (EP1731512), WO 2007/123853, WO 2007/075459, WO2009/002809, WO 2008/019760, WO 2008/122375, WO 2008/128711, WO 2009/097992, WO 2010/072781, WO 2010/072781, WO 2008/126665, WO 2007/125984, WO 2008/130651, JP 2008110971, JP2008133273, WO2009/022746, WO 2009/022746, WO 2010/032437, WO2009/080250, WO2010/020521, WO2010/025998, WO2010/020522, WO2010/084067, WO2010/086225, WO2010/149506 and WO2010/108733, all of which are incorporated herein by reference. No compounds from this class have yet been commercialised.

It has now surprisingly been found that compounds from the above class are highly potent against ants and have the property of non-repellency, making these compounds suitable for use in the control of ants. Thus compounds that are insecticidally active by antagonism of the gamma-aminobutyric acid (GABA)-gated chloride channel, and which comprise a partially saturated heterocycle that is substituted by a haloalkyl substituent and one or two optionally substituted aromatic or heteroaromatic rings, represent a potentially valuable new solution for combating ant infestation.

In a general aspect the invention provides a method of controlling ants comprising applying as a non-repellent anticide a compound that is insecticidally active by antagonism of the gamma-aminobutyric acid (GABA)-gated chloride channel, and which comprises a partially saturated heterocycle that is substituted by a haloalkyl substituent and one or two optionally substituted aromatic or heteroaromatic rings, as a non-repellent formicide to a location where ant control is needed or is expected to be needed.

In a first aspect the invention provides a method for controlling ants comprising applying a liquid formulation comprising a compound of formula I to a location where ant control is needed or is expected to be needed, wherein the compound of formula I is as defined above.

The method may comprise applying a compound of formula I to a first location to control ants at a second location, wherein the second location is remote from the first location, e.g. the method may comprise controlling ants at a second location by applying a compound of formula I to a first location, wherein the second location is remote from the first location. The non-repellency and slow action of the compounds of the invention may allow ants to pick up a lethal dose of compound and transfer the compound to other members of the colony, e.g. after traveling back to the nest, thereby potentially exposing a large number of ants at the locus of the colony, e.g. the nest, to the compounds that have not directly come into contact with the compound. With a sufficient number of ants transferring the compound back to the nest, ultimately the colony may be destroyed. Thus the amount of compound in the environment, e.g. in the soil, at the second location may be at sub-lethal levels, or even may be substantially zero, with control of the ant population at the second location arising from inter-ant transfer.

The second location may be the ant nest. The first location may be a location that is not the ant nest, e.g. an area of relatively low concentration of ants. The first location may be e.g. up to 1, 2, 5, 10, 15, 20, 25 or even up to 30 meters away from the nest.

The location where ant control is needed or is expected to be needed may be treated with a compound of formula I such that the concentration of compound at the location is sufficient to kill ants whilst allowing the ants to carry the compound of formula I away from the location of application, e.g. to the nest.

The compounds of the invention may be applied to surfaces where ant activity takes place or is expected to take place, e.g. as a residual application, e.g. in the form of a spray. For example, for protecting buildings from ants the compound may be applied around the perimeter of a building.

In some cases ant nests are directly sprayed or drenched with insecticide, for example fire ants produce distinctive mounds that can be directly treated.

For residual application of compounds of formula I the rate of application may be from 1 to 500 mg/m², preferably from 25 to 200 mg/m². For example, rate of application may be at least 1 mg/m², preferably at least 25 mg/m². For example the rate of application may be less than 500 mg/m², preferably less than 200 mg/m².

The compounds of the invention may also be used in ant baits. An ant bait may be a material consumable by ants, e.g. sugar and/or protein based material, depending on the type of ant to be controlled. For example, leaf cutter ants are usually controlled by bait matrices based on citrus pulp. The skilled person is able to select appropriate bait material for the type of ant to be controlled. The compound may be applied to the bait after the bait is at the desired location and/or may be applied to the bait during construction, e.g. the material may be impregnated with a compound of the invention.

In a further aspect the invention provides a method for controlling ants comprising locating an ant bait comprising a compound of formula I where ant control is needed or is expected to be needed. In a further aspect the invention provides an ant bait comprising a compound of formula I.

The method may comprise locating a bait comprising a compound of formula I to a first location to control ants at a second location, wherein the second location is remote from the first location, e.g. the method may comprise controlling ants at a second location by locating a bait comprising a compound of formula I to a first location, wherein the second location is remote from the first location. The second location may be the ant nest. The first location may be a location that is not the ant nest, e.g. an area of relatively low concentration of ants. The first location may be e.g. up to 1, 2, 5, 10, 15, 20, 25 or even up to 30 meters away from the nest.

For bait application of compounds of formula I the compound of the invention may be present in the ant bate from 1 to 2000 ppm, preferably from 10 to 500 ppm. For example, the compound of the invention may be present at least 1 ppm, preferably at least 10 ppm. For example the compound of the invention may be present up to 2000 ppm, preferably up to 500 ppm.

For the purposes of this invention the term nest is defined as the place where the reproductive ants and brood are to be found. The term “colony” describes the ants in a single population.

In one embodiment the invention provides a method for controlling, e.g. eradicating, the reproductive ants in a nest comprising applying a compound of formula I to a location remote from the nest.

In a further aspect the invention provides use of a compound of the invention as a non-repellent anticide.

Non limiting examples of ant genera which may be controlled by compounds of the invention include Solenopsis, Linepithema, Lasius, Monomorium, Camponotus, Paratrechina, Tapinoma, Technomyrmex, Pheidole, Tetramorium, Messor, Atta, Acromyrmex, Crematogaster and Myrmica. Examples of these include Solenopsis invicta (red imported fire ant), Linepithema humile (Argentine ant), Lasius nige, Lasius neglectus (Black garden ant), Monomorium pharaonis (Pharaoh ant), Paratrechina spp. (Crazy ants), Tapinoma melanocephalum (Ghost ant), Tapinoma sessile (Odorous house ant), Technomyrmex albipes (White footed ant), Pheidole megacephala (Bigheaded ant), Tetramorium caespitum (Pavement ant), Messor structor (Harvester ant), Atta spp. (Leaf cutter ants), Acromyrmex spp. (Leaf cutter ants), Crematogaster spp. (Acrobat ants), Myrmica rubra (European fire ant), Camponotus spp. (Carpenter ants).

Of particular interest are leaf cutter ants, which are pests of many crops and in particular eucalyptus trees. In a further aspect the invention provides a method of protecting useful plants from leaf cutter ants, comprising locating a bait comprising the compound of formula I in the vicinity of the useful plants or the locus of the useful plants. Such useful plants are for example trees, e.g. Eucalyptus trees. For leaf cutter ants the bait will usually be citrus-based. In particular the invention provides a method of protecting a eucalyptus tree plantation from leaf cutter ants, comprising locating a bait comprising the compound of formula I to a location, e.g. in the vicinity of the plantation, where leaf-cutter ant activity is occurring or is expected to occur. Bait for control of leaf cutter ants are usually based on a citrus pulp matrix and the baits are scattered around areas where leaf cutter ants have been identified.

Also of particular interest are carpenter ants. In a further aspect the invention provides a method of protecting useful wood from carpenter ants, comprising applying the compound of formula I to the wood, or placing a bait in the vicinity of the wood. The wood may be a man-made structure, e.g. a building or furniture. In one embodiment the invention provides a method of protecting wood from leaf carpenter ants, comprising locating a bait comprising the compound of formula I to a location where carpenter ant activity is occurring or is expected to occur.

The formulations of the invention may contain formulation ingredients such as carriers, additives, surfactants etc., as is known to the person skilled in the art.

By the term “carrier” is meant an organic or inorganic material, which can be natural or synthetic, and which is associated with the active ingredient and which facilitates its application to the locus to be treated. This carrier is thus generally inert and should be acceptable for use on the contemplated or treated locus. The carrier can be solid (clay, silicates, silica, limestone, gypsum, ceramics, resins, wax, fertilizers, etc.) or liquid (water, alcohols, ketones, oil solvents, saturated or unsaturated hydrocarbons, chlorinated hydrocarbons, liquified petroleum gas, etc.).

Among the many additives, the compositions of the invention can comprise surfactants as well as other ingredients such as dispersants, stickers, antifoam agents, antifreezing agents, dyestuffs, thickeners, adhesives, protective colloids, penetrating agents, stabilizing agents, sequestering agents, antiflocculating agents, corrosion inhibitors, pigments and polymers. More generally, the compositions of the invention can contain all kinds of solid or liquid additives which are known in the art of insecticides and insecticidal treatments.

Surfactants can be of the emulsifying or wetting type, ionic or non-ionic. Possible surfactants are salts of polyacrylic or lignosulfonic acids; salts of phenolsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. When the spraying vehicle is water, the use of at least one surfactant is often desirable.

Bait may include nutritional feeding stimulants. Baits may also include attractants. Ant baits are often applied within bait stations that protect the bait from non-target organisms (including children), the environment, etc., yet allow access to ants.

Solid compositions can be powders for dusting or for dispersion and granules, especially extruded, agglomerated or compacted granules, or granules which have been made by impregnation of a powder. Liquid compositions or compositions which have to be liquid or dispersed in a liquid when applied include solutions, water-soluble concentrates, emulsifiable concentrates, suspensions, suspension concentrates, suspoemulsions, emulsions, wettable powders or pastes or water-dispersible granules. In order to obtain these wettable powders or dusting powders, it is appropriate to intimately mix the active ingredients and the additives, as by grinding in a mill or similar device. Dispersible granules are generally made by agglomeration of a powder, followed by an appropriate granulation process. The emulsions herein described can be of the oil-in-water or water-in-oil types. Fluidity of the emulsions can range from low viscosities up to high viscosities approaching those of gels. Among these many compositions or formulations, one skilled in the art can choose the one most appropriate, according to the specific conditions of the treatment problem.

In one preferred embodiment the compound of formula I is a compound of formula IA, in particular a compound selected from Table A

In another preferred embodiment the compound of formula I is a compound of formula IB.

In a preferred embodiment the invention provides a method for controlling ants comprising applying a liquid formulation comprising a compound of formula IA to a location where ant control is needed or is expected to be needed, wherein the compound of formula IA is as defined above.

In a preferred embodiment the invention provides a method for controlling ants comprising applying a liquid formulation comprising a compound of formula IB to a location where ant control is needed or is expected to be needed, wherein the compound of formula IB is as defined above.

The invention will now be described by way of non-limiting Examples.

### EXAMPLE 1

Washed sand was treated with the experimental compound diluted in acetone. The acetone was allowed to evaporate, and the sand thoroughly mixed. De-ionised water was added to the treated sand to give a final water content of 3%. The treated sand was then packed into a glass tube with an internal diameter of 13.2 mm, to produce a 4 cm column. This was held in place at one end with a section of 7% agar. Sections of filter paper were placed at both ends of the column. Approximately 25 mixed age termites were added to the end of the tube containing the agar. Both ends were then sealed with rubber bungs. Assessments were made 1, 2, 3, 7 and 21 days after infestation, measuring termite mortality and the distance tunnelled into the treated sand. Results are shown in the Table 1 and Table 2

TABLE 1

| | | Mortality/average % | | | | |
|---|---|---|---|---|---|---|
| | Concentration/ | 1 | 2 | 3 | 7 | 21 |
| Compound | ppm | DAA | DAA | DAA | DAA | DAA |
| 22 + 23 | 100 | 25 | 30 | 62 | 93 | 100 |
| 22 + 23 | 1 | 2 | 22 | 78 | 98 | 100 |
| Fipronil | 0.1 | 0 | 28 | 33 | 77 | 100 |
| Fipronil | 0.01 | 7 | 7 | 7 | 7 | 52 |
| control | | 0 | 0 | 0 | 0 | 0 |

TABLE 2

| | | Mortality/average % | | | | |
|---|---|---|---|---|---|---|
| | Concentration/ | 1 | 2 | 3 | 7 | 21 |
| Compound | ppm | DAA | DAA | DAA | DAA | DAA |
| A | 100 | 5 | 5 | 12 | 12 | 15 |
| A | 1 | 22 | 40 | 40 | 40 | 40 |
| Fipronil | 0.1 | 27 | 30 | 40 | 40 | 40 |
| Fipronil | 0.01 | 27 | 40 | 40 | 40 | 40 |
| control | | 22 | 22 | 30 | 30 | 40 |

Compound A was a mixture of compounds 22 and 23 according to Table A
DAA = days after application

There was no mortality among the termites in the control, indicating that they were in good health, and the test methodology was not detrimental to them. It took longer than expected for the control termites to tunnel through the 4 cm sand column, however, this was not considered to indicate a problem with the assay.

The standard, fipronil, caused the expected levels of termite mortality, with mortality expressed within the expected time frame for this compound at these rates. Termites readily tunnelled into treated sand, indicating that at these rates fipronil was not repellent.

Compound A caused significant termite mortality at both application rates, with the onset of mortality occurring earlier than that seen with fipronil. This may be related to the higher application rates used. At the 1 ppm application rate, termites readily tunnelled through the treated sand, indicating a non-repellent mode of action. At the 100 ppm rate the termites only made short tunnels into the treated sand. This indicates that at very high rates compound A has some repellent effect. This is also seen with fipronil at high rates. The similar levels of termite mortality seen at 1 and 100 ppm suggests that at the lower rate the termites readily tunnel into the soil, picking up a lethal dose. At the higher rate, they are partially repelled from the sand, but pick up a lethal dose from the reduced exposure to a higher concentration of termiticide.

Compound A is a potent termiticide with non-repellent activity. The delayed onset of mortality, and readiness to tunnel into treated sand, suggests this compound would exhibit the so called “liquid bait” effect, where exposed termites bring the termiticide back to the colony and pass it on to initially unexposed individuals.

### EXAMPLE 2

Washed sand is treated with the experimental compound in a volatile solvent, so as to deliver the desired concentration w/w in the solvent free sand. Once the solvent has evaporated, the sand is thoroughly mixed and made up with deionised water to 3% w/w moisture content. Ca. 5 g of the so treated sand is placed in the base of a 9 cm Petri dish. 20 worker termites are placed on the treated sand and placed in a dark room under similar temperature to their culture colony. After 6 hours the termites are assessed for mortality and carefully removed from the treated sand, before being placed in a similar Petri dish of untreated sand (3% moisture content). 20 further termites are taken from the same colony and placed in the Petri dish with the exposed termites, along with a section of filter paper ca. 2 cm². The lid of the Petri dish is replaced and sealed with laboratory film. The so constructed Petri dish arena are placed in a dark room with a similar temperature to the culture colony. Assessments of total termite mortality, symptomology and behaviour are made at daily intervals.

TABLE 3

| Days | 2 | 3 | 6 | 7 | 8 | 9 | 10 | 13 | 14 | 15 | 16 | 17 |
|---|---|---|---|---|---|---|---|---|---|---|---|---|
| % | 0 | 14 | 30 | 38 | 43 | 50 | 67 | 78 | 83 | 87 | 88 | 92 |
| control | 5 | 5 | 5 | 5 | 5 | 5 | 5 | 5 | 5 | 5 | 5 | 8 |

Table 3 shows the % mortality at given time points (days) after application. 10 ppm of compound 1 from Table A was used.

TABLE 4

| | | Days after treament | | | | | | | | |
|---|---|---|---|---|---|---|---|---|---|---|
| Compound | ppm | 0 | 1 | 2 | 3 | 6 | 7 | 8 | 9 | 14 |
| 1 | 10 | 0 | 19.5 | 23.5 | 27.5 | 32.5 | 33.5 | 35 | 35.5 | 37.5 |
| 1 | 5 | 0 | 0.5 | 1.5 | 1.5 | 1.5 | 6 | 6 | 7 | 7.5 |
| 1 | 2.5 | 0 | 0 | 0.5 | 0.5 | 0.5 | 1 | 1 | 1.5 | 1.5 |
| 5 | 5 | 0 | 20.5 | 42 | 44 | 52.5 | 54.5 | 56.5 | 56.5 | 65.5 |
| 65.55 | 2.5 | 0 | 15 | 31 | 32 | 42 | 46.5 | 46.5 | 49.5 | 56 |
| 5 | 1.25 | 0 | 3 | 12 | 12 | 20 | 24 | 25 | 26.5 | 30 |
| 1b | 5 | 0 | 15 | 33.5 | 40.5 | 52.5 | 59.5 | 60 | 61.5 | 63.5 |
| 1b | 2.5 | 0 | 10 | 19 | 22.5 | 27 | 36 | 36.5 | 37 | 38 |
| 1b | 1.25 | 0 | 1.5 | 3.5 | 5.5 | 6 | 6 | 6 | 6.5 | 6.5 |
| control | | 0 | 0 | 0 | 0.5 | 0.5 | 0.5 | 0.5 | 1 | 1 |

Table 4 shows the % mortality of the total termites at given time points after introduction. The compounds used were compounds I and 5 from Table 1A, and compound 1b from Table 1B.

In Table 3 there was no initial mortality, but a gradual increase over a few days reaching >90% in two weeks. This indicates that the initially exposed termites would have had the opportunity to get back to the main part of the colony and passed on the insecticide to termites who didn't come in contact with the treated sand.

In Table 4 there was no mortality after 6 hours and greater than 50% after 6 days, indicating that the toxicant was being passed to termites that had not initially been exposed.

Taken together, this is evidence that the compounds are being transferred from initially exposed termites to termites that haven't come in contact with the treated sand. Taken with the earlier findings from Example 1 that termites are not repelled by sand treated with the ISIS compounds (within a certain rate range) we can conclude that they would act as classic non-repellent termiticides such as fipronil and would be expected to have the so called “liquid bait” effect.

1. A method for controlling termites comprising applying a liquid formulation comprising a compound of formula I to a location where termite control is needed or is expected to be needed, wherein the compound of formula I is 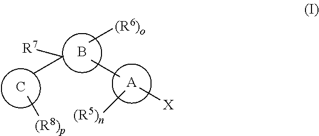
wherein
X is optionally substituted aryl, optionally substituted heterocyclyl, or a group selected from X1 to X5 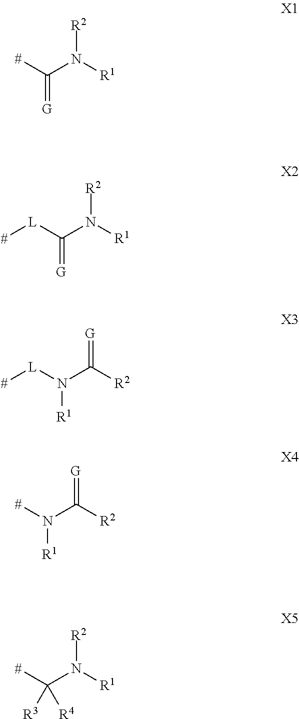
cycle A is aryl or heteroaryl;
cycle B is a saturated or partially unsaturated heterocyclyl;
cycle C is aryl or heteroaryl;
R¹, R², R³, R⁴, R⁵, R⁶ and R⁸ are independently hydrogen or an organic radical;
R⁷ is haloalkyl;
G is oxygen or sulfur;
L is O, NH, NR¹, CR³R⁴;
n is 0, 1, 2, 3, 4 or 5;
o is 0, 1, 2, 3, 4 or 5;
p is 1, 2, 3, 4 or 5.

2. A method according to claim 1, wherein the compound of formula I is a compound of formula IA 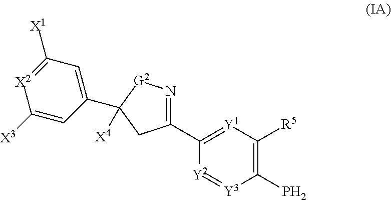
wherein P is P0 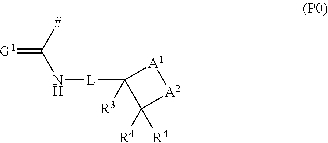
or P is selected from P1 to P54 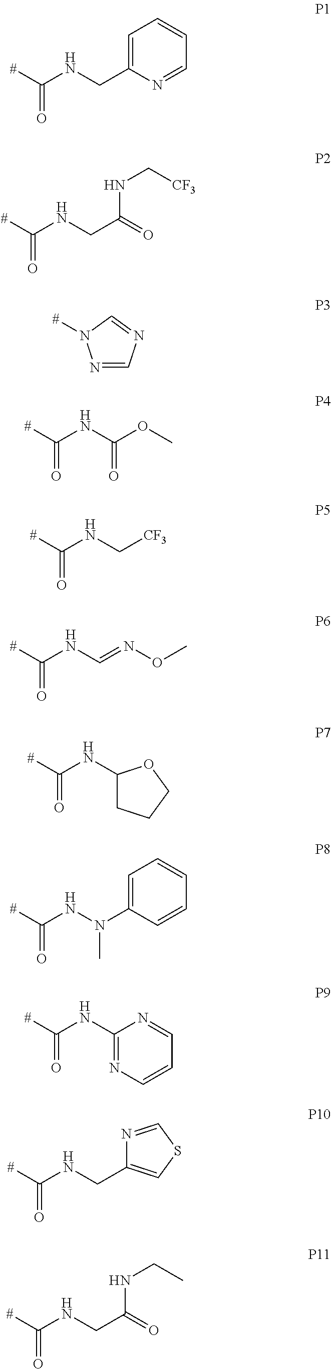 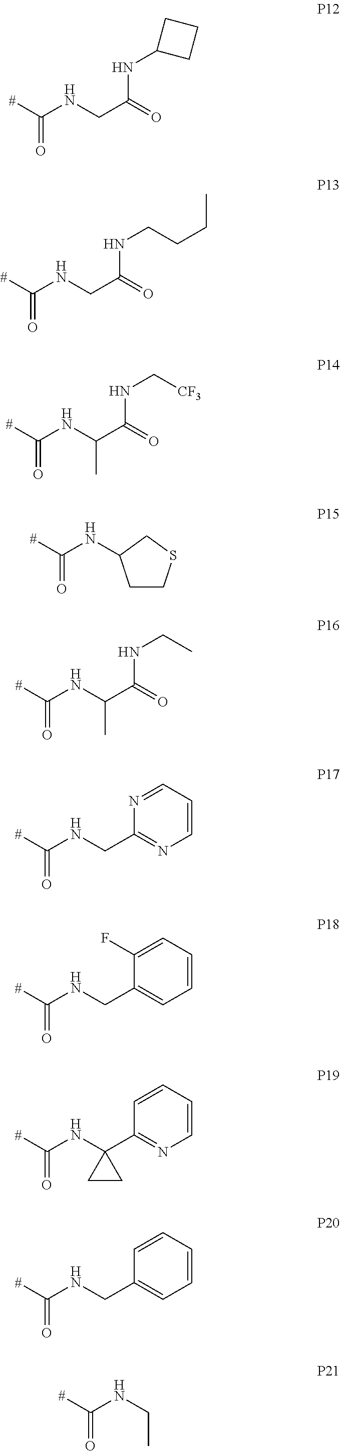 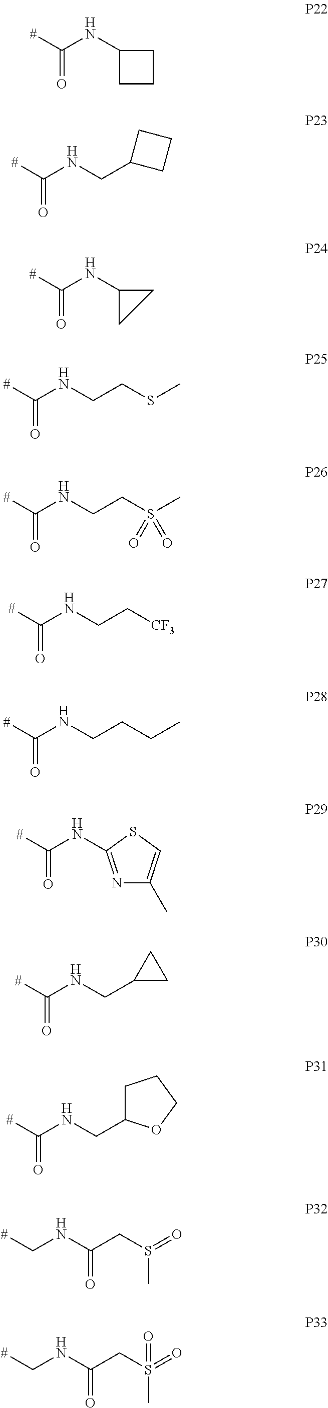 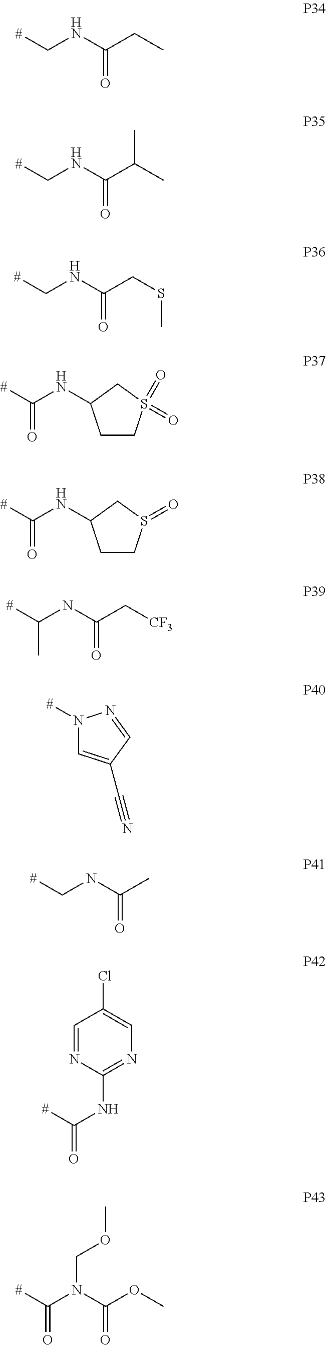 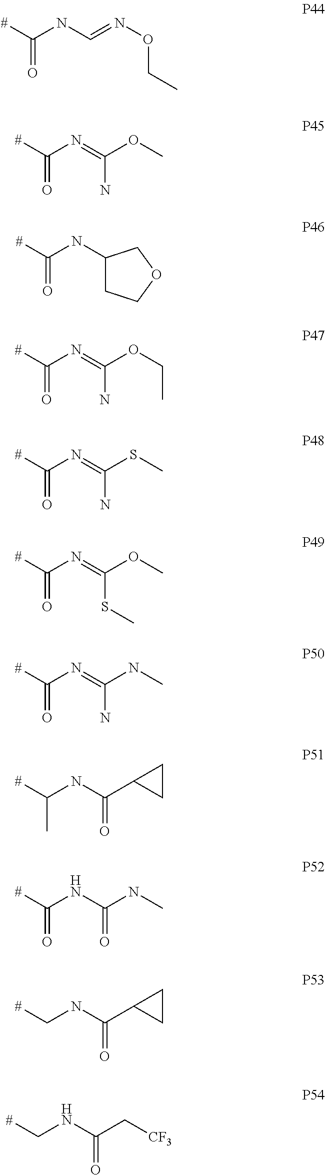
G¹ is oxygen;
G² is O or CH₂;
L is a bond, methylene or ethylene;
one of A¹ and A² is S, SO or SO₂ and the other is —C(R⁴)R⁴—;
R³ is hydrogen or methyl;
each R⁴ is independently hydrogen or methyl;
Y¹ is C—R⁶, CH or nitrogen;
Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₂alkyl, C₁-C₂haloalkyl, C₃-C₅cycloalkyl, C₃-C₅halocycloalkyl, C₁-C₂alkoxy, C₁-C₂haloalkoxy;
R⁶ together with R⁵ forms a —CH═CH—CH═CH— bridge;
X² is C—X⁶ or nitrogen;
X¹, X³ and X⁶ are independently hydrogen, halogen or trihalomethyl, wherein at least two of X¹, X³ and X⁶ are not hydrogen;
X⁴ is trifluoromethyl, difluoromethyl or chlorodifluoromethyl.

3. A method according to claim 1, wherein the compound of formula I is a compound of formula IB 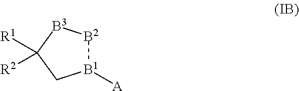
wherein —B¹-B²-B³— is —C═N—O—, —C═N—CH₂—, or —N—CH₂—CH₂—;
R¹ is trifluoromethyl, difluoromethyl or chlorodifluoromethyl;
R² is group X 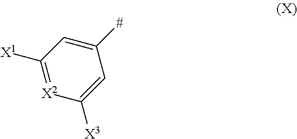
X² is C—X⁶ or nitrogen;
X¹, X³ and X⁶ are independently hydrogen, halogen or trihalomethyl, wherein at least one of X¹, X³ and X⁶ is not hydrogen;
A is selected from group A1 to A5 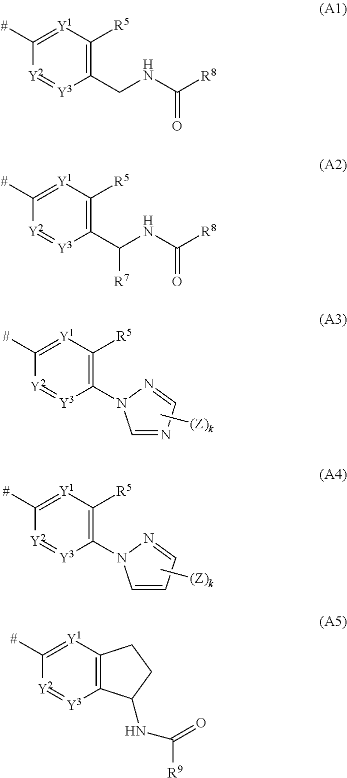
Y¹ is C—R⁶, CH or nitrogen;
Y² and Y³ are independently CH or nitrogen;
wherein no more than two of Y¹, Y² and Y³ are nitrogen and wherein Y² and Y³ are not both nitrogen;
R⁵ is hydrogen, halogen, cyano, nitro, NH₂, C₁-C₄alkyl, C₁-C₄haloalkyl, C₃-C₅cycloalkyl, C₃-C₅halocycloalkyl, C₁-C₂alkoxy, or C₁-C₂haloalkoxy;
R⁶ when present together with R⁵ forms a —CH═CH—CH═CH— bridge;
R⁷ is C₁-C₄alkyl;
R⁸ is C₁-C₄alkyl, C₁-C₄haloalkyl, C₁-C₄alkoxy(C₁-C₄)alkyl, C₁-C₄alkylthio(C₁-C₄)alkyl, C₁-C₄alkylsulfinyl(C₁-C₄)alkyl, C₁-C₄alkylsulfonyl(C₁-C₄)alkyl, C₃-C₆cycloalkyl, C₃-C₆cycloalkyl(C₁-C₄)alkyl-, or tetrahydrofuranyl;
R⁹ is C₁-C₄alkyl, C₁-C₄haloalkyl, C₁-C₄alkyl-O—CH₂—, C₁-C₄haloalkyl-O—CH₂—, C₃-C₆cycloalkyl, or C₃-C₆cycloalkyl-CH₂—, C₁-C₄alkyl-S—CH₂—, C₁-C₄alkyl-S(O)—CH₂—, C₁-C₄alkyl-S(O₂)—CH₂;
each Z is independently halogen, C₁-C₁₂alkyl or C₁-C₁₂alkyl substituted by one to five R¹², nitro, C₁-C₁₂alkoxy or C₁-C₁₂alkoxy substituted by one to five R¹², cyano, C₁₂alkylsulfinyl, C₁-C₁₂alkylsulfonyl, C₁-C₁₂haloalkylsulfinyl, C₁-C₁₂haloalkylsulfonyl, hydroxyl or thiol;
each R¹² is halogen, cyano, nitro, hydroxy, C₁-C₈alkoxy-, C₁-C₈haloalkoxy-, mercapto, C₁-C₈alkylthio-, or C₁-C₈haloalkylthio; and
k is 0, 1, 2 or 3.

4. A method according to claim 1, wherein the method is for controlling termites at the location of a termite nest by applying the compound at a location remote from the termite nest.

5. A method according to claim 1, wherein the compound of formula I is applied as a non-repellent termiticide.

6. A method according to claim 1, comprising controlling termites at a second location by applying a compound of formula I to a first location, wherein the second location is remote from the first location.

7. A method according to claim 6, wherein the second location is a termite nest.

8. A method according to claim 1, wherein the location where termite control is needed or is expected to be needed is treated with a compound of formula I such that the concentration of compound at the location is sufficient to kill termites whilst allowing the termites to carry the compound of formula I away from the location of application.

9. A method according to claim 1, wherein the compound of formula I is applied as a liquid formulation to soil and wherein the liquid formulation applied to the soil contains less than 1% of the compound of formula I.

10. A method according to claim 1, wherein the compound of formula I is applied as a liquid formulation to soil and wherein the liquid formulation applied to the soil contains from 0.01 to 1% by weight of the compound of formula I.

11. A method according to claim 1, wherein the location is a man-made structure or in and/or around the area where the man-made structure is to be located.

12. A method according to claim 11, wherein the structure is a building.

13. A method according to claim 1, wherein the liquid formulation is included with a termite bait.

14. A termite and/or ant bait comprising a compound of formula I as defined in claim 1.

15. (canceled)

16. A method according to claim 1, wherein P is selected from P1, P2 and P55 to P64

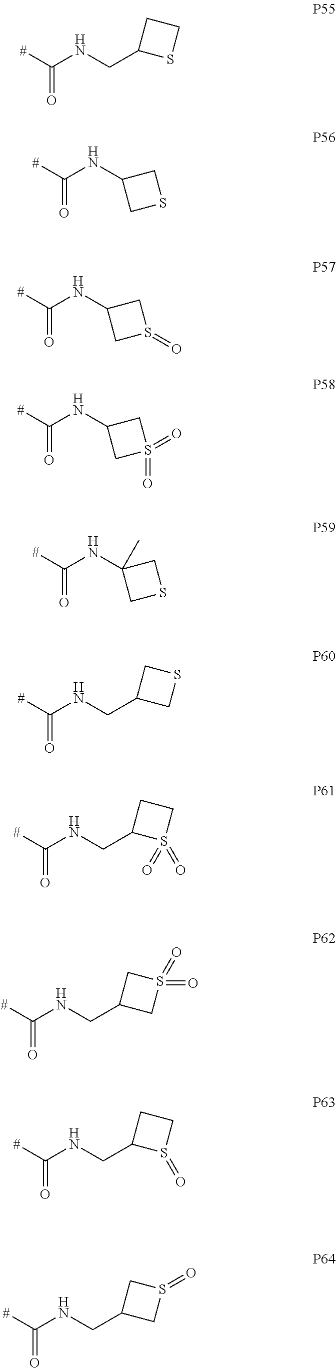

17. A method according to claim 1, wherein P is selected from P2, P56, P57 and P58.

18. A method according to claim 1, wherein P is P57.

19. A method according to claim 1, wherein X² is C—X⁶, Y¹, Y² and Y³ are C—H, G¹ is oxygen, G² is oxygen, A¹ is CH₂, A² is S, SO or SO₂, L is a bond, R³ and each R⁴ is hydrogen, R⁵ is chloro, bromo, methyl or trifluoro methyl, Y¹ is CH, Y² is CH, and Y³ is CH, X⁴ is trifluoromethyl.

20. A method for controlling ants comprising applying a liquid formulation comprising a compound of formula I to a location where ant control is needed or is expected to be needed, wherein the compound of formula I is a compound as defined in claim 1.

21. A method according to claim 20, wherein the method is for controlling ants at the location of an ant nest by applying the compound at a location remote from the ant nest.

22. A method according to claim 20, wherein the compound of formula I is applied as a non-repellent formicide.

23. A method according to claim 20, comprising controlling ants at a second location by applying a compound of formula I to a first location, wherein the second location is remote from the first location.

24. A method according to claim 20, wherein the location where ant control is needed or is expected to be needed is treated with a compound of formula I such that the concentration of compound at the location is sufficient to kill ants whilst allowing the ants to carry the compound of formula I away from the location of application.

25. A method according to claim 20, wherein the compound of formula I is applied as a residual liquid formulation comprising a compound of formula I to a surface where ant activity occurs is expected to occur at a rate of up to 500 mg/m², preferably 25 to 200 mg/m².

26. A method according to claim 20, wherein applying is to a man-made structure and/or around the man-made structure.

27. A method according to claim 26, wherein the man-made structure is a building.

28. A method according to claim 20, wherein the liquid formulation is included with an ant bait.

29. (canceled)

30. (canceled)

31. A method according to claim 20, wherein controlling includes protecting a eucalyptus tree plantation from leaf cutter ants, and wherein applying includes locating a bait comprising the compound of formula I as defined in claim 1 to a location where leaf-cutter ant activity is occurring or is expected to occur.
